(19) United States
(12) Patent Application Publication
(10) Pub. No.: US 2025/0283811 A1
(43) Pub. Date: Sep. 11, 2025

(54) VARIABLE WAVELENGTH INTERFEROMETRY

(71) Applicant: Onto Innovation Inc., Wilmington, MA (US)

(72) Inventors: Alexander George BOOSALIS, Lake Oswego, OR (US); Nigel P. SMITH, Hillsboro, OR (US); George Andrew ANTONELLI, Flanders, NJ (US)

(73) Assignee: Onto Innovation Inc., Wilmington, MA (US)

(21) Appl. No.: 19/071,685

(22) Filed: Mar. 5, 2025

Related U.S. Application Data
(60) Provisional application No. 63/563,260, filed on Mar. 8, 2024.

(51) Int. Cl. G01N 21/45; H04N 23/71; H04N 23/74

(52) U.S. Cl. CPC G01N 21/45; H04N 23/71; H04N 23/74

(57) ABSTRACT

A variable wavelength interferometer operates in the back focal plane of the objective and produces a narrow band illumination beam with a peak wavelength that is varied over a range of wavelengths. An interferometric objective directs light to the sample and a reference surface and recombines the reflected light to produce interference. At least one polarizer generates one or more polarization states of the sample illumination and of the reference illumination. One or more path length differences between the sample and reference illumination is produced. At least one camera captures images of the interference illumination at a back focal plane of the interferometric objective for each combination of peak wavelength and polarization state. The interferometric data at one or more pixels of the camera are used to extract structural information for the sample.

### CLAIM OF PRIORITY

This application claims the benefit of and priority to U.S. Provisional Application No. 63/563,260, filed Mar. 8, 2024, and entitled “VARIABLE WAVELENGTH INTERFEROMETRY,” which is assigned to the assignee hereof and is incorporated herein by reference in its entirety.

### FIELD OF THE DISCLOSURE

The subject matter described herein is related generally to optical metrology, and more particularly to interferometry.

### BACKGROUND

Semiconductor and other similar industries often use optical metrology equipment to provide non-contact evaluation of substrates during processing. One type of optical metrology is scanning white-light interferometry.

A scanning white-light interferometer uses broadband light that is split to produce a probe beam and a reference beam, which when combined produces an interference pattern. A scanning white-light interferometer conventionally produces a plurality of images of a sample using various path differences between the combined beams. Analysis of the resulting interference fringes with respect to the path differences at each pixel of the detector (which corresponds to points on the sample surface) provides three dimensional information for surface height profiles of a sample. Thus, the data collected by a scanning white-light interferometry system that is focused with a given spot size on a given site on a semiconductor wafer contains information may describe the local stack of thin films and its pattern. The spot size required for this measurement in theory can be diffraction limited, which in a white-light system requires the illumination at the surface to come from a large range of incident angles. Since the sample reflectance changes with incident angle, determination of sample properties from this information is impractical in all but a few cases, restricting use of the instrument to measurement of surface topography.

### SUMMARY

A variable wavelength interferometric metrology device, as discussed herein, operates in the back focal plane of the objective and uses a wavelength tunable light source to produce a narrow band illumination beam with variable peak wavelength. An interferometric objective directs light to the sample and a reference surface and recombines the reflected light to produce interference. At least one polarizer generates one or more polarization states of the sample illumination and of the reference illumination. In some implementations, two or more path length differences between the sample and reference illumination may be produced. At least one camera captures images of the interference illumination at the back focal plane of the interferometric objective for each combination of peak wavelength and polarization state, and multiple path length differences if used. The interferometric data at one or more pixels of the camera are used to extract structural information for the sample, e.g., by determining the complex reflectance of the sample, where complex reflectance of the sample is the ratio of the electric field incident on and the electric field reflected by the sample.

In one implementation, a method of characterizing a sample with an interferometer includes generating a narrow band illumination beam with a peak wavelength that is varied over a plurality of wavelengths and generating interference illumination with an interferometric objective from the narrow band illumination beam that includes reference illumination that is incident on and reflected by a reference surface and sample illumination that is incident on and reflected by the sample and generating interference of the interference illumination with the interferometric objective by recombining reflected sample illumination and reflected reference illumination. The method further includes using at least one polarizing element to generate one or more polarization states in the sample illumination at each peak wavelength and to generate one or more polarization states in the reference illumination at each peak wavelength. Further, the method includes capturing images with at least one camera at a back focal plane of the interferometric objective to produce interferometric data for each combination of peak wavelength and polarization state and using the interferometric data at one or more pixels of the at least one camera to extract structural information for the sample.

In one implementation, an interferometer configured to characterize a sample, includes a light source that generates a narrow band illumination beam with a peak wavelength that varies over a plurality of wavelengths and an interferometric objective that generates interference illumination from the narrow band illumination beam that includes reference illumination that is incident on and reflected by a reference surface and sample illumination that is incident on and reflected by the sample and that generates interference of the interference illumination by recombining reflected sample illumination and reflected reference illumination. The interferometer additionally includes at least one polarizing element that generates one or more polarization states in the sample illumination at each peak wavelength and generates one or more polarization states in the reference illumination at each peak wavelength. The interferometer further includes at least one camera that captures images at a back focal plane of the interferometric objective to produce interferometric data for each combination of peak wavelength and polarization state, and at least one processor that extracts structural information for the sample using the interferometric data at one or more pixels of the at least one camera.

### BRIEF DESCRIPTION OF THE DRAWINGS

FIG. 1 illustrates a scanning white-light interferometer system.

FIG. 2 illustrates a graph showing the fringe contrast with respect to the sample interval for a scanning white-light interferometer system.

FIG. 3 illustrates a general design of a wavelength scanning interferometer device.

FIGS. 4A, 4B, and 4C schematically illustrate system designs for the wavelength scanning interferometer device of FIG. 3.

FIG. 4D schematically illustrates a collection arm with a multiple camera implementation.

FIGS. 5A, 5B, and 5C illustrate interferometric objectives with a Mirau configuration, Michelson configuration, and Linnik configuration, respectively.

FIGS. 6A, 6B, 6C, 6D, and 6E illustrate various configurations of beamsplitters that may be used with the wavelength scanning interferometer device.

FIGS. 7A and 7B illustrate perspective and top plan views of a sensor with a polarizing mask.

FIG. 8 is a graph illustrating the relative signal value with respect to the path difference varying by multiples of 90° in a 2×2 pixel block of the sensor shown in FIGS. 7A and 7B.

FIG. 9 is a flow chart illustrating a method of operating a variable wavelength interferometer device.

FIG. 10 illustrates two light sources with varying emission spectra used for simulation of variable wavelength interferometer measurements.

FIGS. 11-18 illustrates the results of simulations for variable wavelength interferometer measurements.

### DETAILED DESCRIPTION

A variable wavelength interferometry system as discussed herein includes hardware and an analytical method to extract structural information from a sample by acquiring interferometric data at a plurality of different wavelengths. The variable wavelength interferometry system uses an optical spot size that is at least the size of the diffraction limitation, and may be less than 10 μm, and collects images at the back focal plane of the objective rather than the image plane. The variable wavelength interferometry system determines the complex reflectance properties of the sample, which may be determined as a ratio between incident and emergent electric fields.

Conventional interferometry systems, such as a scanning white light interferometry system, use the full spectrum of light and scan the path difference between the reference and probe beams and may use a Fourier Transform to extract spectral sample reflectance values.

The variable wavelength interferometry system, as discussed herein, varies the wavelength of a narrow-bandwidth light source and enables measurement of pattern geometries and spatial variation of pattern geometries with small extent in samples, such as semiconductor devices, using a small probe. The variable wavelength interferometry system enables an increase in the data content to as many wavelengths and incident angles as desired, the number of incident angles being limited only by the numerical aperture of the illumination optical system, thereby improving pattern measurement capabilities.

The variable wavelength interferometry system collects measurements at multiple wavelengths. Additionally, measurements may be collected at multiple polarization states of the reference and sample illumination. In some implementations, the variable wavelength interferometry system may further collect measurements at one or more path length difference between the reference and sample illumination for each wavelength. For example, each wavelength may be measured with at least two path length differences. It should be understood that the variable wavelength interferometry system may sample wavelengths at regular or irregular intervals or may use a continuous variation of wavelengths and may be sometimes referred to herein as a scanning wavelength interferometry system without loss of generalization. The use of wavelength scanning reduces the impact of vibration, of dispersion in optical components and allows optimizing signal to noise ratio (SNR) on a wavelength-by-wavelength basis.

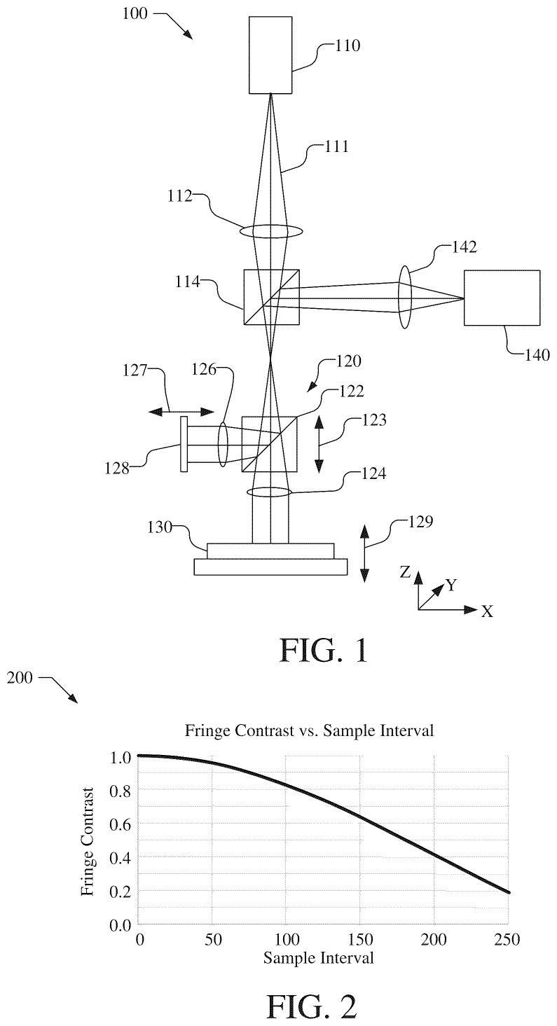

FIG. 1 illustrates a conventional scanning white-light interferometer 100 that scans the path difference between the reference and probe beams and uses a Fourier Transform to extract spectral sample reflectance values. A scanning white-light interferometer 100 suffers from several problems and complications.

The scanning white-light interferometer 100 may be used to extract structural information from a sample using an optical spot size that may be less than 10 μm. The data collected by a scanning white-light interferometry system focused with a given spot size on a given site on a semiconductor wafer contains information describing the local stack of thin films and its pattern. The spot size required for this measurement can in theory be diffraction limited. The scanning white-light interferometer 100 relies on operation in the back focal plane of the objective rather than the image plane. Data for a continuous range of wavelengths defined by the spectrum of the light source and angles of incidence defined by the numerical aperture (NA) of the optical system can be simultaneously measured at each of a plurality of optical path differences in the sample and reference arms of the interferometer.

The scanning white-light interferometer 100 includes a light source 110 that produces a broadband illumination beam 111. Various optical elements, illustrated by lens 112 and beam splitter 114 direct the broadband illumination beam 111 to the interferometric objective 120. The interferometric objective 120 is configured to split the light into the sample arm and a reference arm. The interferometric objective 120 is illustrated as a Linnik configuration, but other configurations may be used, such as the Michelson configuration or Mirau configuration. The broadband illumination beam 111 is split by a beam splitter 122 and a portion is directed through the sample arm through an objective 124 to be incident on and reflected by the sample 130, while a second portion is directed through the reference arm through an objective 126 to be incident on and reflected by a reference mirror 128. The reflected light from the sample 130 and reference mirror 128 are recombined by the beam splitter 122 and directed to a camera 140 via the beam splitter 114 and one or more optical elements, illustrated by lens 142. The camera 140 acquires images of the back focal plane of the objective while varying the path difference between the arms of an interferometric objective 120. For example, the length of the sample arm may be altered by moving the interferometric objective 120 towards or away from the sample 130, as illustrated by arrow 123, or the sample 130 towards or away from the interferometric objective 120, as illustrated by arrow 129, both of which alters the focus of the sample illumination on the sample 130 and alters the size of the optical spot on the sample 130. In another example, the length of the reference arm may be altered by moving the objective 126 and mirror 128 as illustrated by arrow 127. The scanning white-light interferometer 100 requires that the path difference is altered and many data points, e.g., measurements, are captured at regular intervals during the scan in order to use a Fourier-transform.

A pixel-by-pixel Fourier Transform of the image intensity as a function of path difference may be used to measure the complex reflectance of the system as a function of wavelength, angle of incidence and azimuth angle. The spectral content of the data is limited by the spectrum of the light source 110, and the range of incident angles is limited by the NA of the optical systems and any obstructions present in the optical path (such as the reference mirror in a Mirau configuration. Collection of the largest possible range of incident angles requires using the highest possible NA. Extraction of the sample reflectance involves the construction of a system level model of the hardware which incorporates hardware-based calibrations into the model to be fit to the raw data.

If the path difference scan is implemented by moving the sample relative to the optical elements (as illustrated by arrows 123 or 129) while keeping the reference path fixed, for example by moving away from focus, then the spot size on the sample 130 will vary during acquisition. The rate at which the spot size changes with defocus will increase with NA of the objective lens. As NA approaches 1, defocus by the wavelength of light (λ) becomes significant. At the same time, the wavelength resolution for a scan of length L varies as 2λ²/L, so that scans with length L of 60 μm or more are required to achieve resolution of 10 nm at λ=600 nm. Consequently, focus on the sample 130 is typically fixed during the scan and the reference arm is moved (as illustrated by arrow 127), i.e., a Michelson configuration or Linnik configuration (as illustrated in FIG. 1) may be used. Different wavelengths, however, have different focal positions. The fixed focal position is typically selected as an average of the focal lengths for all wavelengths of interest, with the understanding that the focal position may not be the best focal position for some wavelengths.

The speed with which the scanning white-light interferometer 100 can perform a measurement is limited by the speed at which the physical scan (illustrated by arrow 127) can be performed. In most cases, the speed is not necessarily limited by the moving mass but by the intensity of the light source and the exposure time required to achieve near saturation intensity levels in the camera 140, or by the maximum frame rate of the camera and image acquisition hardware. If shot noise dominates other sources then the signal-to-noise ratio (SNR, defined as Signal/Noise, so that higher values are better) for N stored electrons in the sensor is √N. Hence the best SNR requires the highest possible N, which is limited by the well depth of the sensor, meaning signals are desired to be as close as possible to the saturation level of the sensor.

Images are acquired by the camera 140 as the path difference is changed in the interferometric objective 120. A pixel at the same location (x,y) in every image corresponds to a single angle of incidence (AOI, symbol θ) and azimuth angle (ϕ). Provided that the path difference (ζi) at image i is known, a Fourier transform of the image intensity I(x,y, ζ) produces a complex result S(θ, ϕ, k), where k is spatial frequency and is related to sample wavelength by k=2π/h. Ideally, the interval, Δζ, between consecutive images should be constant during any scan because that allows use of Fast Fourier Transform (FFT) algorithms. Deviations from constant spacing arising from vibration, scan nonlinearity or any other means introduce either a requirement to measure ζi accurately and use a slower Discrete Fourier Transform (DFT) conversion or result in a reduction in the quality of the measurement. An alternative approach that may improve uniformity is to monitor ζ during the scan and trigger the capture of images whenever it changes by the desired interval.

In the Linnik configuration illustrated in FIG. 1, or with a Michelson configuration, the focus position, z, remains unchanged while the reference arm is scanned (as illustrated by arrow 127). If the reference arm is moved in discrete steps, then uncertainty in the ζi positions arises from encoder errors and overshoot or undershoot in the movement. These stop and start errors may be significant. Therefore, the scan may be implemented as a continuous rather than discrete movement. Smearing of the signal occurs because the phase changes as each image is exposed, and this reduces the modulation of the interference signal from which the sample spectrum is obtained. The highest modulation may be desirable. The reduction in signal modulation is negligible provided that

$$Δζ ≪ \frac{λ}{2 π} \qquad eq . 1$$

For the implementations with λ≈600 nm, the requirement becomes that the scan interval, Δζ, is less than 100 nm. In the current implementation the interval is normally 60 nm and the fringe contrast drops to 93% of the theoretical value. FIG. 2 illustrates a graph 200, for example, showing the fringe contrast with respect to the sample interval.

Scan lengths of 60 μm are used to achieve wavelength resolution of 10 nm. Image intervals of 60 nm or less are required to avoid image smearing and loss of contrast. A typical scan therefore consists of 1000 images, or more if multiple images are averaged to further improve SNR. The smallest total time required to perform this scan is therefore 1000T, where T is the interval between images. If required, the exposure time may be shorter than T, which will reduce the contrast loss due to smearing but reduce the signal for a given incident intensity.

With a camera 140 that can run at a maximum of Fₘₐₓ frames per second T is greater than or equal to 1/Fₘₐₓ, and the scan duration is 1000/Fₘₐₓ or longer. Frame rates of 1000 FPS or more are required to achieve sub-second Move-Acquire-Measure (MAM) times and wavelength resolution of 10 nm or better. A lower limit for T is the image exposure time (E). The exposure times are determined by the intensity of the light source 110, efficiency of the optical system, and quantum efficiency of the camera, so that signal levels are just less than saturation, and may be 5-30 ms, depending on spot size. The frame rate is the maximum that can be achieved with these exposure time, plus any overhead required to extract the image data, so that T≥E. With available cameras, scan durations will therefore be in the range 1-30 s.

The instrument should operate with the shortest possible MAM time combined with the best SNR. Increasing the intensity of the light source, or the efficiency of the optical system, can be used to reduce MAM time and increase SNR, subject to the constraint that the maximum frame rate is limited by the capabilities of the camera. Once this frame rate is realized, further increase in light intensity will require a reduction in exposure time to avoid image saturation. Selecting a camera with the highest possible well depth and fastest possible frame rate provides the best combination of MAM time and SNR, since for a well depth of W and light levels close to saturation (N stored electrons=W), the maximum SNR is VW.

As the path difference changes, the signal in the scanning white-light interferometer 100 consists of oscillations of period near half the dominate incident wavelength of approximately 600 nm with an envelope controlled by the coherence of the light source 110. The Fourier Transform of the envelope is dominated by the spectrum of the light source 110, modified by the spectral reflectivity of the sample and system components.

The relationship between the source intensity at different wavelengths is fixed. Adjusting the camera exposure time to control image intensity does not allow weak parts of the source spectrum to be enhanced. If noise is constant, then the SNR as a function of wavelength is proportional to the source spectrum and is much worse at low-intensity wavelengths than at strong ones.

In the scanning white-light interferometer 100, the signal level at selected points in the spectrum may be boosted by filtering out unwanted wavelengths. Therefore, limiting the source spectrum to a wavelength range of 400-800 nm may be used to avoid the strong Xenon emission lines above 800 nm. Extension to shorter wavelengths than 400 nm may be desirable but may be prevented by absorption in some optical components.

Light sources are available that offer control over the source spectral content. These devices can generate a source with constant intensity versus wavelength, but since that is achieved by attenuating stronger regions the maximum intensity is limited by the weakest part of the original source spectrum. As discussed above, regarding the effect of light intensity on SNR and MAM time, reducing the intensity at all wavelengths to the lowest level would require a significant increase in MAM or decrease in SNR.

Performing a Fourier Transform of the scan signal at each pixel from the scanning white-light interferometer 100 gives the relative amplitude (A) and phase (φ) of the modulation in the detected image intensity. These are related to the combined system and sample Jones Matrix as follows, where ϕ is the azimuth angle and the Jones Matrix is also dependent on the incident angle θ:

$$JonesMatrix = ( \begin{matrix}{J}_{pp} & {J}_{sp} \\ {J}_{ps} & {J}_{ss}\end{matrix} ) = ( \begin{matrix}\vert {J}_{pp} \vert {e}^{i {Δ}_{pp}} & \vert {J}_{sp} \vert {e}^{i {Δ}_{sp}} \\ \vert {J}_{ps} \vert {e}^{i {Δ}_{ps}} & \vert {J}_{ss} \vert {e}^{i {Δ}_{ss}}\end{matrix} ) \qquad eq . 2$$

$$A = \frac{{I ( ϕ , θ )}^{2}}{{I}_{source}^{2}} = {\vert {J}_{pp} \vert}^{2} {cos}^{4} ϕ + {\vert {J}_{sp} \vert}^{2} {cos}^{2} ϕ {sin}^{2} ϕ + {\vert {J}_{ps} \vert}^{2} {cos}^{2} ϕ {sin}^{2} ϕ + {\vert {J}_{ss} \vert}^{2} {sin}^{4} ϕ + cos ϕ sin ϕ \{ \begin{matrix}2 \vert {J}_{pp} \vert \vert {J}_{sp} \vert {cos}^{2} ϕ cos ( {Δ}_{pp} - {Δ}_{sp} ) - \\ 2 \vert {J}_{pp} \vert \vert {J}_{ps} \vert {cos}^{2} ϕ cos ( {Δ}_{pp} - {Δ}_{ps} ) - \\ 2 \vert {J}_{pp} \vert \vert {J}_{ss} \vert cos ϕ sin ϕ cos ( {Δ}_{pp} - {Δ}_{ss} ) - \\ 2 \vert {J}_{sp} \vert \vert {J}_{ps} \vert cos ϕ sin ϕ cos ( {Δ}_{sp} - {Δ}_{ps} ) - \\ 2 \vert {J}_{sp} \vert \vert {J}_{ss} \vert {sin}^{2} ϕ cos ( {Δ}_{sp} - {Δ}_{ss} ) + \\ 2 \vert {J}_{ps} \vert \vert {J}_{ss} \vert {sin}^{2} ϕ cos ( {Δ}_{ps} - {Δ}_{ss} )\end{matrix} \} \qquad eq . 3$$

$$φ ( ϕ , θ ) = {tan}^{- 1} \frac{\begin{matrix}\vert {J}_{pp} \vert {cos}^{2} ϕ sin {Δ}_{pp} + \vert {J}_{sp} \vert cos ϕ sin ϕ sin {Δ}_{sp} - \\ \vert {J}_{ps} \vert cos ϕ sin ϕ sin {Δ}_{ps} - \vert {J}_{ss} \vert {sin}^{2} ϕ sin {Δ}_{ss}\end{matrix}}{\begin{matrix}\vert {J}_{pp} \vert {cos}^{2} ϕ cos {Δ}_{pp} + \vert {J}_{sp} \vert cos ϕ sin ϕ cos {Δ}_{sp} - \\ \vert {J}_{ps} \vert cos ϕ sin ϕ cos {Δ}_{ps} - \vert {J}_{ss} \vert {sin}^{2} ϕ cos {Δ}_{ss}\end{matrix}} \qquad eq . 4$$

For a purely reflecting sample in perfect focus, a scan position at which the optical path difference between the sample and reference paths in the interferometer is the same at all pixels, may be defined as an origin for the scan position, ζₒ, and the measured phase at each pixel may be determined solely by the characteristics of the sample and optical system. Uncertainty in this position, whether through inaccurate positioning of the reference components or defocus of the sample, changes the phase measurements by a constant amount. This error can be corrected by calibration of reference mirror position combined with measurement of defocus, for example using a sensor; adjusted by fitting the signals to a model of light scattering at the sample; or by subtraction of a value or values at pre-determined locations. In the case of subtracting a sample value, the phase measurements become relative to those points.

Calibration may be used to estimate the effect of the system and combined with a sample Jones Matrix derived from a model of the sample structure to generate a simulated signal. The model parameters that best describe the sample may be found by comparing experimental and simulated signals.

Thus, in general, the scanning white-light interferometer 100 using path difference scanning uses step intervals of 75 nm or less, total scans of 10 μm or more, path differences, ζi, for each image that are known or predictable, a platform with low system vibration over periods between the interval between images and the duration of the scan are required, high intensity illumination which is ideally constant with wavelength and with intensity the same for all images, or with variation that can be measured and corrected, and where the transformation between pixel (x,y) and (θ, ϕ) is fixed, or in the worst case is known for each image.

It is desirable to eliminate or mitigate the above problems. As discussed herein, one approach to eliminate or mitigate the above issues is the use of a variable wavelength interferometer that scans multiple discrete wavelengths.

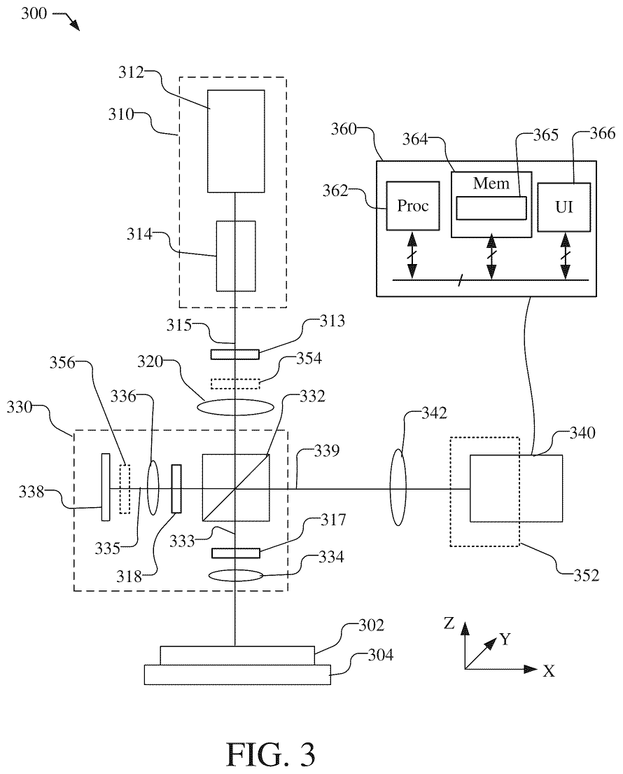

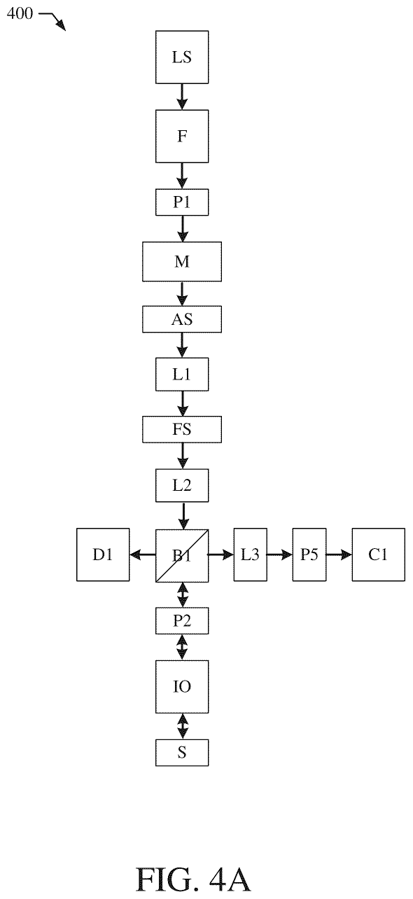

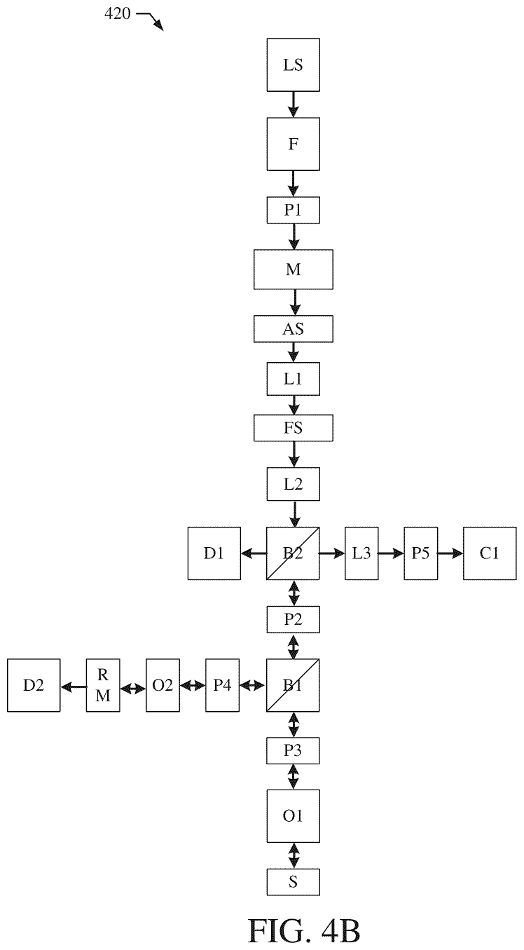

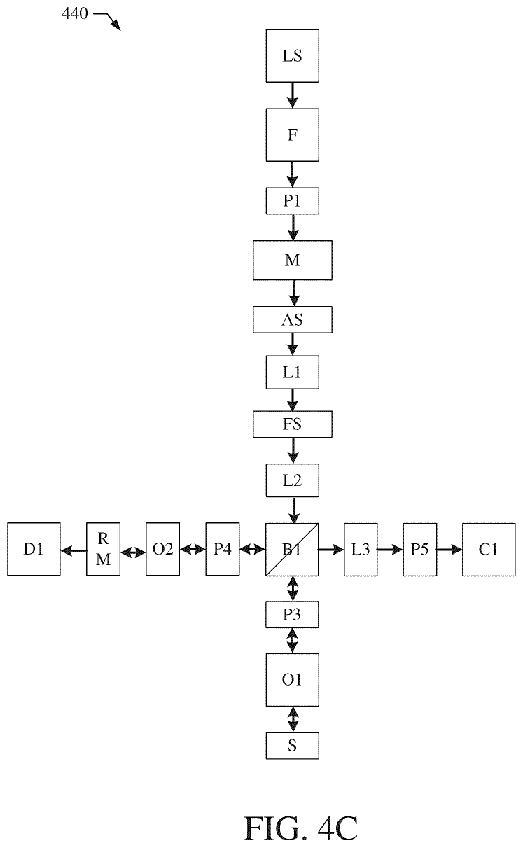

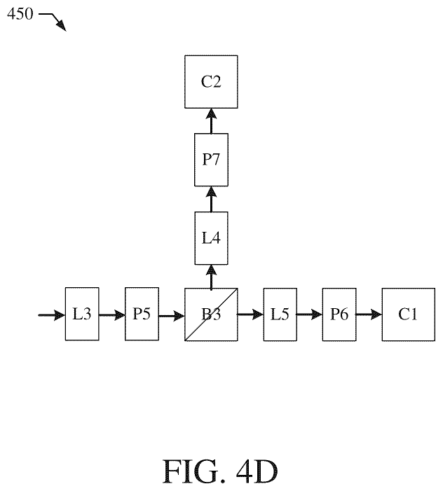

FIG. 3 illustrates a block diagram of an optical metrology device 300, sometimes referred to herein as variable wavelength interferometer 300, that is capable of operating in the back focal plane of the objective to measure one or more physical characteristics of a sample 302. FIG. 3 illustrates a general design of the variable wavelength interferometer, but it should be understood, however, that various more specific designs may be used, as illustrated in FIGS. 4A-4D.

The optical metrology device 300 includes a wavelength tunable light source 310 that produces a narrow band illumination beam 315. The light source 310 is configured to controllably vary a peak wavelength of the narrow band illumination beam 315 over a plurality of wavelengths. The wavelength tunable light source 310 includes an illumination source 312 and, in some implementations, may include an additional wavelength tuning element 314, such as a dynamic monochromator. In some implementations, the wavelength tuning element 314 may be internal to the illumination source 312. By way of example, the illumination source may be a quantum cascade laser (QCL), which is a tunable coherent source. In other implementations, the illumination source 312 may include an incoherent broadband source that is used in conjunction with a wavelength tuning element 314, such as a grating or prism-based monochromator, for example an Energetiq TLS-EQ-77, or an acousto-optic tunable filter (AOTF).

A tunable coherence source (such as a QCL) (which has an internal monochromator) or incoherent broadband source with an external grating or prism-based monochromator are examples of the light source 310 that operate in a similar fashion, in that a static diffracting element is moved to select the peak wavelength of the narrow band illumination beam 315. The rate at which the diffracting element can be moved ultimately limits the switching rate of the monochromator. Reducing the size of the element and the required range of motion is one method of increasing the switching rate, e.g., use of micro-electro-mechanical system (MEMS). The switching rate in general, however, is limited by kinetics.

The wavelength tuning element 314 may be a dynamic diffractive element which has variable diffractive properties, such as an AOTF. An AOTF operates on the principle of the acousto-optic effect wherein a standing acoustic wave in a crystal is used to diffract input light. By tuning the frequency of the excitation source, the associated frequency of the acoustic wave will change and thus change the diffraction of the input light. Switching rates on the order of megahertz can be accomplished with devices such as AOTFs. Thus, an AOTF used in conjunction with incoherent broadband illumination source or an optical system that joins a series of narrow band coherent or incoherent illumination sources, may be used as a fast monochromator in a wavelength tunable light source 310.

In the wavelength-tuned system illustrated in FIG. 3, it is not necessary to collect data at all available wavelengths, unlike the path difference scanning approach illustrated in FIG. 1 where a quasi-continuous wavelength signal supports the use of the Fourier Transform to extract spectral data. The time taken to change wavelengths in the wavelength-tuned system may be additive to the time taken to collect data, and therefore fast switching is desirable. The optimal exposure time at each wavelength is determined by the intensity of the light source 310 and the SNR required to achieve the required measurement capability. The intensity at any wavelength will also depend on the bandwidth of the tunable source at that wavelength, where in most cases intensity increases with larger bandwidth.

Selection of the desired light source 310 may depend on how quickly the light source 310 can change wavelength, bandwidth, intensity, the SNR required for adequate measurement capability and MAM time specification. An AOTF-based light source 310 may be desirable because the switching rate (from kHz to MHz) is likely much faster than the camera's frame rate (Hz to kHz), and hence has minimum impact on MAM time.

The optical metrology device 300 further includes one or more optical elements, illustrated with lens 320 that directs the narrow band illumination beam 315 to an interferometric objective 330. The interferometric objective 330 is illustrated with a Linnik configuration, but other configurations may be used, such as the Michelson configuration or Mirau configuration. The interferometric objective 330 splits the narrow band illumination beam 315 with a beam splitter 332 into sample illumination 333 in a sample arm and reference illumination 335 in a reference arm and recombines the reflected sample illumination 333 and reflected reference illumination 335 which interferes to form interference illumination 339. As illustrated, in the sample arm, sample illumination 333 is directed through an objective 334 to be incident on and reflected by the sample 302, while in the reference arm, reference illumination 335 is directed through an objective 336 to be incident on and reflected by a reference mirror 338. The sample illumination 333 reflected from the sample 302 and the reference illumination 335 reflected from the reference mirror 338 are recombined by the beam splitter 332 to form interference illumination 339, which is directed to one or more cameras 340 via one or more optical elements, illustrated by lens 342. The camera 340 captures images of the interference illumination 339 at the back focal plane of the interferometric objective 330, e.g., objective 334.

Thus, the optical metrology device 300 uses a wavelength tunable light source 310 that produces the narrow band illumination beam 315 with variable wavelengths and images the back focal plane of the objective. In some implementations, the optical metrology device 300 may use only a single data point, e.g., measurement, for each wavelength. Thus, the optical system for the optical metrology device 300, e.g., interferometric objective 330, may use a fixed path difference between the sample arm and reference arm in the interferometric objective 330, i.e., the path difference does not change, for variations in the peak wavelength of the narrow band illumination beam 315 produced by the wavelength tunable light source 310. Moreover, in some implementations, the optical system for the optical metrology device 300, e.g., interferometric objective 330, may use a fixed focal position on the sample 302, i.e., the focal position does not change. In this way, deleterious effects arising from the use of path difference scanning are eliminated. Moreover, maintaining focus on the sample allows the use of a Mirau configuration, if desired, since the change in spot size away from focus is not a factor, unlike conventional path difference scanning systems.

By increasing the number of data points, e.g., measurements, captured at each wavelength, however, the data quality will improve. For example, the phase of the signal received by the camera 340 may be modulated for each wavelength. In some implementations, measurements may be performed for each wavelength at two different phases, which enables the measured phase to expand from a limit of 0 to π for a single measurement to −π to π for two measurements. The phase of the signal may be modulated, for example, using a modulator, illustrated with dotted block 354, or by altering the path difference between the arms of the interferometric objective 330. The modulator illustrated with dotted block 354, for example, may be a photoelastic modulator (PEM) that changes the index of refraction of a crystal, where that index changes the optical path length within the crystal. It should be noted that while the scanning white-light interferometer 100 shown in FIG. 1 alters the path difference, it must scan throughout acquisition of the interference signal and multiple data points are acquired during the scan so that the spectrum may be derived from the FFT. As the length of the scan increases with the scanning white-light interferometer 100, the wavelength resolution improves, e.g., 60 μm scans are typically used. The variable wavelength interferometer 300, on the other hand, is operating with a narrow spectral bandwidth, and the modulation envelope of the interference pattern will vary slowly with the path difference. It is therefore only necessary to move the reference arm of the interferometric objective 330 by a relatively small amount, e.g., the length of a single interference cycle which may be approximately 300 nm, and only two data points may be acquired. If a modulator 354 is used to modulate the phase of the signal, then it is also only necessary to vary the phase delay between 0° and 360°. Accordingly, the time taken to collect the varying wavelength signals at multiple phases is minimized and errors introduced by system vibration are reduced relative to those in a broad bandwidth path difference scanning system, such as illustrated in FIG. 1.

Additionally, in some implementations, the optical system for the optical metrology device 300, e.g., interferometric objective 330, may vary the focal position with respect to the sample 302. For example, the focal position may be adjusted as the peak wavelength of the narrow band illumination beam 315 is varied to place the sample 302 at a desired, e.g., best, focal position for each wavelength.

In operation, the reflectance of the sample, i.e., the complex reflectance properties of the sample, including amplitude and phase change induced by the reflectance of the sample, may be measured by the optical metrology device 300. In general, interferometry devices, such as illustrated in FIG. 1, are conventionally used to measure the relative phase at different locations on a sample surface, which can be used to determine the relative heights at the different locations, i.e., the topography, of the sample. The measurement of reflectance of the sample by the optical metrology device 300, as discussed herein, on the other hand, is not a topography measurement, but a measure of the effectiveness in reflecting radiant energy by the sample, which is a property of the sample materials and structures. The reflectance is a response of the structure of the material in the sample to the electromagnetic field of light and is in general a function of the wavelength of the light, its polarization, the angle of incidence, and the azimuthal angle. The phase change induced by the reflectance of the sample is the phase change between the illumination incident on the sample and the illumination reflected by the sample. The optical metrology device 300 may include one or more components enabling extraction of the phase change that occurs to the sample beam on reflection from the sample 302, e.g., the phase change between the sample illumination that is incident on the sample 302 and the sample illumination reflected from the sample 302.

The extraction of the phase change induced by the reflectance of the sample may be implemented using various components. In one implementation, illustrated with dotted block 352, the extraction of the phase change may be performed at the one or more cameras 340. For example, the sample illumination 333 and reference illumination 335 may be circularly polarized in opposite directions using polarization state generators 317 and 318, respectively, which may include linear polarizers and quarter wave plates. In some implementations, the sample illumination 333 and reference illumination 335 may be linearly polarized orthogonally using polarization state generators 317 and 318, respectively, which may include linear polarizers without accompanying quarter waveplates. In some implementations, the sample illumination 333 and reference illumination 335 may be polarized using a single polarization state generator 313 (shown with dotted lines) that is positioned before the interferometric objective 330, in which case the polarization state generators 317 and 318 may be eliminated. The camera 340 may include a polarization mask that captures images of the interference illumination 339 at a plurality of polarizations, or a plurality of cameras 340 may be used, each capturing images of the interference illumination 339 at a different polarization state. With the captured images of the interference illumination 339 at a plurality of different polarizations, the complex reflectance (i.e., the ratio between incident and emergent electric fields at the sample 302) may be determined, as discussed below.

In one implementation, the extraction of the phase change may be performed by modulating the phase of the interference illumination 339. For example, as illustrated with dotted block 354, a modulator may be used to modulate the narrow band illumination beam 315 to modulate the phase of the interference illumination 339. In another example, the objective 336, and optionally the mirror 338, in the reference arm of the interferometric objective may be moved parallel to the optical axis to alter the path length difference of the reference and sample illumination to modulate the phase of the interference illumination 339. With the captured images of the interference illumination 339 at a plurality of different phases, the complex reflectance (i.e., the ratio between incident and emergent electric fields at the sample 302) may be determined, as discussed below.

In one implementation, illustrated with dotted block 356, the extraction of the complex reflectance may be performed using a shutter in the reference arm, which may be used to block the reference illumination 335 so that the camera 340 may be used to capture images of only the reflected sample illumination 333. The captured images of the interference illumination 339, reflected sample illumination 333, and reflected reference illumination 335 (which may be captured during an initial calibration procedure when no sample is in place), the complex reflectance (i.e., the ratio between incident and emergent electric fields at the sample 302) may be determined, as discussed below.

The one or more cameras 340, as well as other components of the optical metrology device 300, such as the light source 310, stage 304, and controllable optical components, such as rotatable polarizers 313, 317, and 318, modulators, shutters, etc., may be coupled to a processing system 360, such as a workstation, a personal computer, central processing unit or other adequate computer system, or multiple systems. It should be understood that one processor, multiple separate processors or multiple linked processors may be used, all of which may interchangeably be referred to herein as processing system 360. The processing system 360 may be included in, or connected to, or otherwise associated with optical metrology device 300. The processing system 360, for example, may control the positioning of the sample 302, e.g., by controlling movement of the stage 304 on which the sample 302 is held. The stage 304, for example, may be capable of horizontal motion in either Cartesian (i.e., X and Y) coordinates, or Polar (i.e., R and θ) coordinates or some combination of the two. The stage 304 may also be capable of vertical motion along the Z coordinate, e.g., for focusing. In some implementations, the stage 304 may be held stationary while one or more components of the optical system of the optical metrology device 300 moves relative to the sample 302 or both the stage 304 and the one or more optical components may move relative to the other. The processing system 360 may further control the operation of a chuck on the stage 304 used to hold or release the sample 302.

The processing system 360 may also collect and analyze the data obtained from the one or more cameras 340 as discussed herein. The processing system 360 may analyze the interferometer data to extract complex reflectance properties, including amplitude and phase change, and to determine one or more physical characteristics of the sample 302 as discussed herein. The processing system 360, which includes at least one processor 362 with memory 364, as well as a user interface (UI) 366 such as a display and input devices. The memory 364 or a separate storage device, may function as a non-transitory computer-usable storage medium, which may include computer-readable program code 365 that may be used by the processing system 360 for causing the at least one processor 362 control the optical metrology device 300 and to perform the functions including the analysis described herein. The data structures, software code, etc., for automatically implementing one or more acts described in this detailed description can be implemented by one of ordinary skill in the art in light of the present disclosure and stored, e.g., on a non-transitory computer-usable storage medium, which may be any device or medium that can store code and/or data for use by a computer system such as the at least one processor 362. The non-transitory computer-usable storage medium may be, but is not limited to, flash drive, magnetic and optical storage devices such as disk drives, magnetic tape, compact discs, and DVDs (digital versatile discs or digital video discs). A communication port may also be used to receive instructions that are used to program the processing system 360 to perform any one or more of the functions described herein and may represent any type of communication connection, such as to the internet or any other computer network. The communication port may further export signals, e.g., with measurement or inspection results and/or instructions, to another system, such as external process tools, in a feed forward or feedback process, e.g., in order to adjust a process parameter associated with a fabrication process step of the samples based on the measurement results. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described. The results from the analysis of the data may be stored, e.g., in memory 364 associated with the sample and/or provided to a user, e.g., via UI 366, an alarm or other output device. Moreover, the results from the analysis may be fed back to the process equipment to adjust the appropriate patterning step to compensate for any errors detected in the measurements or inspection.

FIGS. 4A, 4B, and 4C schematically illustrate three possible system designs 400, 420, and 440, respectively, for the optical metrology device 300 generally illustrated in FIG. 3. FIG. 4D schematically illustrates the collection arm with a multiple camera implementation. In FIGS. 4A, 4B, 4C and 4D, like designated elements may be the same. Moreover, it should be understood that additional or fewer optical elements may be included in the system designs and additional designs or configurations of the variable wavelength interferometer may be apparent in view of the present disclosure. In FIGS. 4A, 4B, and 4C, the light source is illustrated as element LS, which may be a broadband light source (incoherent or coherent) and the wavelength tuning element is illustrated as element F, which may be an AOTF, or other tuning element, such as a movable diffractive element. In FIGS. 4A, 4B, 4C, and 4D, elements P1-P7 represent polarizing elements such as polarizers and wave plates (some of which may be omitted in different designs), element M is an optional static or variable retarder such as a quarter-wave plate, photoelastic or electro-optic modulator, elements L1-L5 are focusing elements that may be refractive or reflective (some of which may be omitted in different designs), element AS is the aperture stop, element FS is the field stop, elements B1-B3 are beamsplitters (some of which may be omitted in different designs), elements D1-D2 are optional detectors such as photodiodes that may be used to measure the intensity of the light source (LS+F) as the wavelength is varied, elements C1-C2 are cameras, element IO is an interferometric objective, which may be a Mirau, Michelson, or Linnik configuration, element RM is a reference mirror, and elements O1-O2 are objective lenses.

In the various designs illustrated in FIGS. 4A, 4B, and 4C, the light source (LS+F), aperture stop (AS), field stop (FS), and lens (L2) may be selected to make use of the entire NA of the objective lenses and simultaneously achieve a desired optical spot size, e.g., between 2 μm and 50 μm on the sample (S). The lens (L3) projects an image of the back focal plane of the objective on to one or more cameras (C1) and (C2), if used.

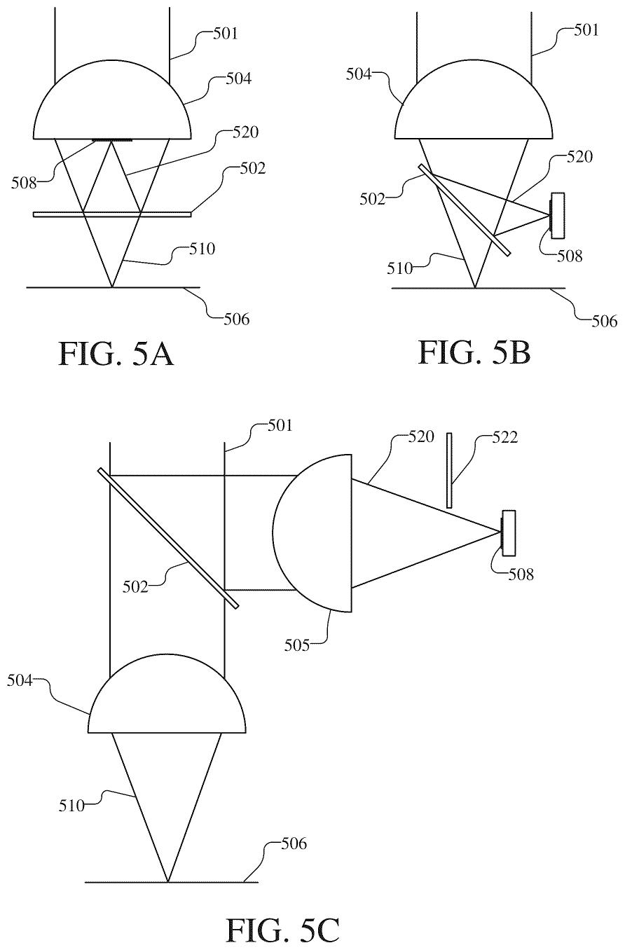

FIGS. 5A, 5B, and 5C illustrate interferometric objectives with a Mirau configuration, Michelson configuration, and Linnik configuration, respectively, which may be used with the optical metrology device 300. In FIGS. 5A, 5B, and 5C, the input illumination 501 is split into sample illumination 510 and reference illumination 520 by a beam splitter 502. The sample illumination 510 is focused by objective lens 504 to be incident on and reflected by a sample 506. The reference illumination 520 is incident on and reflected by a reference mirror 508. In the Mirau configuration shown in FIG. 5A, the reference mirror 508 may be on the objective lens 504. In the Linnik configuration, a second objective lens 505, e.g., which may match the objective lens 504, focuses the reference illumination 520 to be incident on and reflected by a reference mirror 508. The reflected sample and reference illumination are recombined by the beam splitter 502 and interfere with each other to produce the interference illumination.

FIG. 4A illustrates a first design 400, sometimes referred to herein as design I, that includes a single interferometric objective (IO). An example of such an objective is the Mirau configuration illustrated in FIG. 5A. With a Mirau configuration interferometric objective, it is normally not possible to control the polarization state independently in the reference illumination and sample illumination, which may preclude the use of some desired operating modes discussed below. With the variable wavelength interferometer, the use of a Mirau objective configuration does not suffer from a change in probe spot size during acquisition as the interferometric objective if the focal position is held stationary.

FIG. 4B illustrates a second design 420, sometimes referred to herein as design II, that includes a dual beamsplitter design, e.g., with a first beam splitter (B1) in the interferometric objective and a second beam splitter (B2) for directing light to the interferometric objective and the collection arm with camera (C1). The interferometer objective includes an accessible beamsplitter (B1), which separates the sample arm and reference arm, and may use a standard microscope objective O1 before the sample (S). In the Linnik configuration, illustrated in FIG. 5C, a matching objective O2 is also used in the reference arm before the reference mirror (RM), while the Michelson configuration, illustrated in FIG. 5B, does not include the matching objective O2. The configuration in design II permits independent control of the polarization states in the sample and reference arms using polarizers (P3) and (P4), respectively.

FIG. 4C illustrates a third design 440, sometimes referred to herein as design III, that merges the functions of beamsplitters (B1) and (B2) illustrated in FIG. 4B, into a single beamsplitter (B1), which may be more convenient than the configuration of design II shown in FIG. 4B, but otherwise follows the same concepts as design II. With the use of a single beamsplitter (B1), there may be less stray light than in the design II, and fewer partially reflecting surfaces in the beam path, thereby improving overall light efficiency, which benefits SNR.

With any of the designs I, II, and III, shown in FIGS. 4A, 4B, and 4C, respectively, the numerical aperture (NA) of the objectives limits the maximum angle of incidence (AOI) onto the sample (S). In general, it may be desirable to measure the reflection characteristics of the sample (S) over the largest possible range of AOI, and hence the selected objectives should have the highest possible NA that provides acceptable levels of optical aberration.

FIG. 4D illustrates a design 450 for the collection arm receiving light from beamsplitter B1 in the designs I and III, shown in FIGS. 4A and 4C, respectively, or from beamsplitter B2 in the design II shown in FIG. 4B. Design 450 for the collection arm uses multiple cameras (C1) and (C2), which are supported by adding an additional beamsplitter (B3) following polarizer (P5) to direct the light to both cameras (C1) and (C2). The design 450 permits independent control of the polarization states before cameras (C1) and (C2) with optional additional polarizers (P6) and (P7), respectively. Additional focusing lenses (L4) and (L5) may also be used. The second camera (C2) may then be used to provide an image of the sample (S) for alignment purposes, or to provide additional sample information. If desired, additional cameras may be used.

All the designs I, II, and III, may be used with the variable wavelength operation, and in some implementations with path difference scanning, such as illustrated in FIG. 1, or a combination thereof. Support for implementation with path difference scanning may require including moving the interferometric objective (IO) in design I shown in FIG. 4A, or the objective (O2) and the reference mirror (RM) in designs II and III. During variable wavelength operation, the reference arm scanner may be either fixed or adjusted to vary the phase of the signal for each wavelength or to correct for dispersion in the optical system as the wavelength is changed. It may also be desirable to adjust the focus position of the sample (S) so that the sample (S) is kept in focus as the source wavelength is changed.

Suppression of stray light is important for best operation of the instrument as it will reduce signal contrast and lead to poorer SNR. Accordingly, optical components may be tilted rather than oriented perpendicular to the optical axis. Tilting a component, however, deviates the optical path unless a compensating component is used and may introduce undesirable modifications to beam polarization.

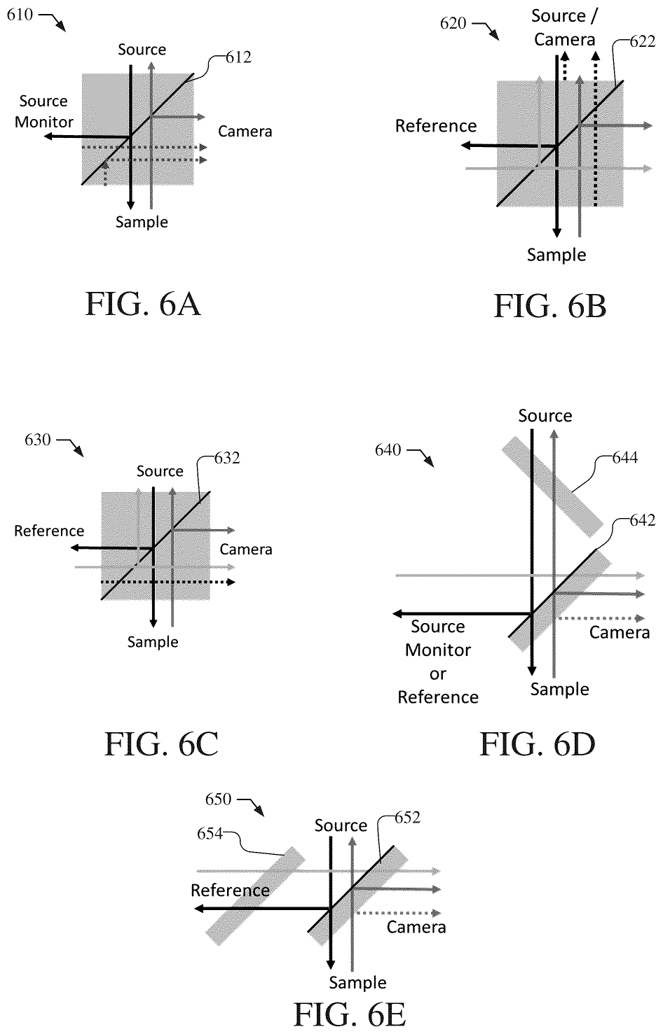

Various types of beamsplitters may be used with any of the designs shown in FIGS. 4A, 4B, 4C, and 4D. FIGS. 6A, 6B, 6C, 6D, and 6E illustrate various configurations of beamsplitters 610, 620, 630, 640, and 650, respectively, that may be used with the optical metrology device 300, in which light from the light source is shown with dark solid lines, light from the sample is shown with dark grey lines, light from a reference mirror is shown with light grey lines, and stray light is shown with dotted lines. Each of the illustrated beamsplitters 610, 620, 630, 640, and 650 have a single reflecting surface (612, 622, 632, 642, and 652, respectively) that divides an incident beam into two beams. Generally, the reflectivity of this surface is 50%, but other values may be used if desired. The reflecting surfaces may be fabricated as a polarizing element, creating a polarizing beamsplitter. Other faces of the beamsplitters may be anti-reflection coated, which may be useful in reducing unwanted reflections.

The beamsplitter 610 shown in FIG. 6A illustrates a cube system design that may be used when the function of combining the source and imaging paths (“system beamsplitter”) is separated from that of the interferometric beamsplitter that splits the sample and reference paths in the interferometric objective, e.g., such as illustrated in designs I and II in FIGS. 4A and 4B. Light returned from the sample path is reflected to the camera, which may include stray light reflected from that path or from a source monitor, e.g., D1 in designs I and II in FIGS. 4A and 4B. A similar beamsplitter may be used as beamsplitter B3 in the multiple camera design illustrated in FIG. 4D.

The beamsplitter 620 shown in FIG. 6B illustrates a cube design interferometric beamsplitter that might be used as part of a Michelson or Linnik interferometric objective, e.g., component IO in FIG. 4A or beamsplitter B1 in FIG. 4B, that is used in conjunction with a system beamsplitter, as shown in designs I and II in FIGS. 4A and 4B. If the beamsplitter 620 is not tilted with respect to the optical axis, stray reflections from the upper and lower surfaces may be incident on the camera and wash out the signal, and thus, it may be desirable to tilt beamsplitter 620.

The beamsplitter 630 shown in FIG. 6C illustrates a cube design that combines the functions of the system beamsplitter (combining the source and imaging paths) and the interferometric beamsplitter (combining the sample and reference paths), as shown in design III in FIG. 4C. All four faces of the beamsplitter 630 are used.

As illustrated by the beamsplitter 640 shown in FIG. 6D, the cube beamsplitters illustrated in FIG. 6A, 6B, or 6C may be replaced by reflecting surfaces angled at, for example, 45° to the optical axis. The use of beamsplitter 640 may avoid unwanted back reflections, but may shift the beams, in the same way that including a cube beamsplitter does. An anti-reflection coated compensating plate 644 arranged perpendicular to the reflecting face 642 may be used to correct for this deviation.

The beamsplitter 650 shown in FIG. 6E illustrates an arrangement of angled reflective surface 652 and compensating plate 654 that combines the functions of the system beamsplitter (combining the source and imaging paths) and the interferometric beamsplitter (combining the sample and reference paths), as shown in design III in FIG. 4C. The compensating plate 654 is located in the reference arm so that both sample and reference beams experience the same total path delay, because each beam passes twice through one plate (the reference beam travels twice through compensating plate 654 and the sample beam travels twice through the plate supporting the reflective surface 652). The compensating plate 654 may be arranged parallel or orthogonal to the main reflective surface 652. Small rotations of the compensating plate 654 may be used to correct for systematic path differences in the two arms, arising for example from differences in the focal lengths of objectives O1 and O2, shown in FIG. 4C.

When linear polarizing components are used in the variable wavelength interferometer, the orientation between polarizer axes and the sample may be controlled when the goal is to measure the way in which the sample modifies the light intensity and polarization state. Consequently, it may be desirable to know the orientation of patterns on the sample and either rotate the sample to align the patterns to axes defined in the system or to rotate the optical elements, e.g., the linear polarizing components, to align to the patterns on the sample. Another alternative is to correct for any misalignment in the orientation of optical elements and patterns on the sample during analysis.

Varying the type and orientation of the polarizing elements shown in FIGS. 4A, 4B, 4C, and 4D modifies the behavior of the variable wavelength interferometer system and the information it collects. Any of the system designs permit operation in multiple modes provided that all system polarizers are at least independently selectable between two states, e.g., 0°, and 90°. In some modes, one or more of the polarizing elements may be quarter-wave plates, which may be used in conjunction with or in place of one or more polarizers. Moreover, in some modes the polarizing elements may include an arrangement of multiple polarizers and/or quarter-wave plates at each location with a rotary, linear or other mechanism to select each one.

The polarizer (P1) and static or variable retarder (M) pair illustrated in FIGS. 4A, 4B, and 4C constitute a polarization state generator (PSG), which can be used in multiple modes. Photo-elastic or electro-optic modulators are examples of variable retarders, where the retardance is controlled by varying an applied voltage appropriately. If retarder (M) is a variable retarder, its retardance may be varied to alter the phase for each wavelength. Further, the retardance may be varied appropriately as the wavelength is changed to produce a constant retardation across the entire wavelength range. A constant offset in the retarder M may be used as a fast way of switching between the S and P polarization states without moving polarizer (P1). Additionally, the retarder M may be used to compensate for systematic wavelength dependent retardation inherent in the optical system, e.g., diattenuation.

In some implementations, the camera (C1) used in any of designs I, II, and III shown in FIGS. 4A, 4B, and 4C, may include a sensor with a polarizing mask, with which the phase of the signal may be determined. An example of such a sensor is the Sony IMX250MZR which has an array of linear polarizing filters arranged at multiples of 45° to the sensor axes in blocks of 2×2 pixels.

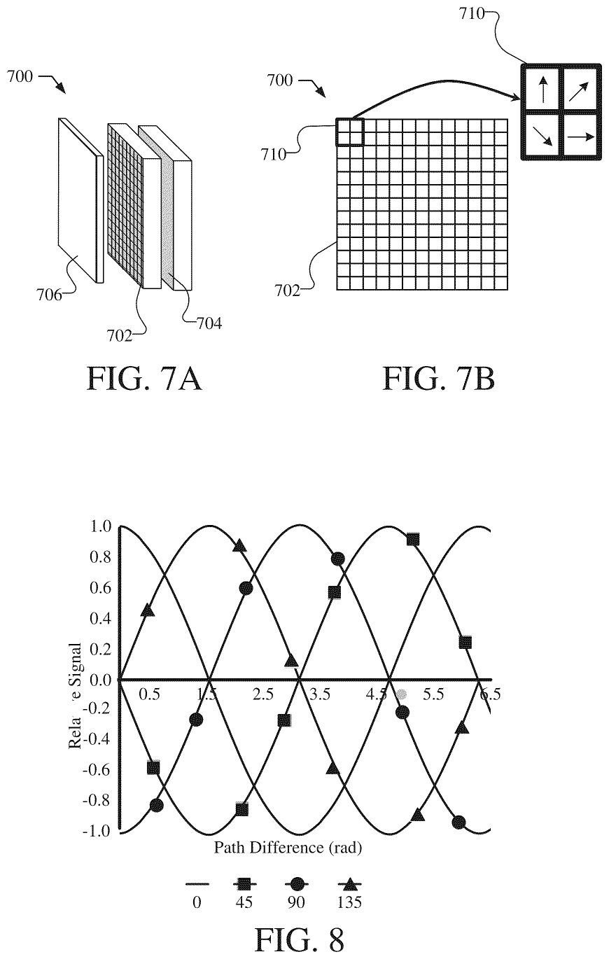

FIGS. 7A and 7B, by way of example, illustrates perspective and top plan views of one implementation of a sensor 700 with a polarizing mask that may be used as a phase sensor in camera (C1). Other implementations of phase sensors may be used if desired. As shown in FIG. 7A, a pixelated polarizer mask array 702 (e.g., pixelated wire grid polarizer array) is bonded or otherwise constructed to be a part of sensor array 704, that could be for instance a CCD or CMOS type. Optionally, a quarter-waveplate 706 may be bonded to the pixelated polarizer mask array forming a combined mask. The quarter-waveplate 706 may also be placed elsewhere in the imaging system. As illustrated in top plan view and the inset of FIG. 7B, the pixelated polarizer mask array 702 is a repeating pattern of blocks (sometimes referred to as unit cells) 710 that include 2×2 pixels having linear polarizing filters arranged at multiples of 45° to the sensor axes, e.g., 0°, 45°, 90°, and 135°.

Examples of different operation modes of the variable wavelength interferometer designs, illustrated in FIGS. 4A, 4B, and 4C, are illustrated in Table 1 below. In Table 1, example combinations of polarizers, beamsplitter, and cameras leading to different system functionality (modes A-G) are illustrated, where Design refers to designs I, II, and III shown in FIGS. 4A, 4B, and 4C, respectively. In Table 1, P1, P2, P3, P4, and P5 refer to the polarizers illustrated in FIGS. 4A, 4B, 4C, and 4D, where LP θ indicates a linear polarizer at angle θ to the sample, QWP θ indicates the addition of quarter-wave plate at angle θ to the sample, and a blank cell indicates that the particular component is omitted, or optionally configured as described below. In Table 1, B1 refers to beamsplitter B1 in FIGS. 4A, 4B, and 4C, which may be non-polarizing (NP) or polarizing (P). In Table 1, Sensor refers to the sensor of the camera (C1) in designs I, II, and III shown in FIGS. 4A, 4B, and 4C, which may be “polarized” referring to a sensor incorporating a polarizing mask, as discussed in FIGS. 7A and 7B, and “standard” referring to a sensor without such a mask.

TABLE 1

| Mode | Design | P1 | P2 | B1 | P3 | P4 | P5 | Sensor |
|---|---|---|---|---|---|---|---|---|
| A | I, II, | LP | LP | NP | | | | Standard |
| | | θ | θ | | | | | |
| B | I, II, | | | NP | | | LP φ | Standard |
| | III | | | | | | | |
| C | II, III | | | NP | LP θ | LP θ + 90 | QWP | Polarized |
| | | | | | | | θ + 45° | |
| D | II, III | | | NP | LP θ | LP θ + 90 | | Polarized |
| E | II, III | | | P | QWP θ | QWP | | Standard |
| | | | | | | 45° | | |
| F | II, III | | | P | QWP θ | QWP | QWP 45° | Polarized |
| | | | | | | 45° | | |
| G | II,III | | | P | QWP θ | QWP | | Polarized |
| | | | | | | 45° | | |

In a first mode of operation, e.g., Mode A in Table 1, linear polarization and signal magnitude detection may be performed with the variable wavelength interferometer having any of designs I or II shown in FIGS. 4A and 4B. The operation in Mode A uses linear polarization at the sample (S), which is achieved using a linear polarizer at one or both of polarizers (P1) and (P2). If both polarizers (P1) and (P2) are present, then the polarization axes are aligned. A third polarizer at the same angle may be positioned before the camera (C1), i.e., polarizer (P5), which may serve to reduce the effect of stray light in different polarization states. Additional optional polarizers, e.g., polarizers (P3) and (P4), at the same orientation may be added for the same reason. In order to preserve the polarization state created by any of these polarizers, the beamsplitters (B1 and B2) may be the non-polarizing (NP) variety. The polarizers may be at any angle with respect to the sample axes, i.e., the axes of the patterns on the sample (S), such as 0°, 45°, or 90°. The selected orientation of the polarizers may be varied based on the sample (S) to optimize the sample contribution to the signal.

In a second mode of operation, e.g. Mode B in Table 1, linear polarization and signal magnitude detection may be performed with the variable wavelength interferometer having any of designs I, II, and III shown in FIGS. 4A, and 4B, and 4C. The operation in Mode B uses linear polarization at the sample (S) utilizing polarizer P1. The polarizer P1 may be at any angle with respect to the sample axes, i.e., the axes of the patterns on the sample (S), such as 0°, 45°, or 90°. The selected orientation of the polarizer may be varied based on the sample (S) to optimize the sample contribution to the signal. A second linear polarizer (P5) is placed before the detector or array of detectors and may be oriented at the same angle as the incident polarizer (P1) or any other angle (φ). The output polarizer (P5) may be rotated in order to modulate the signal for phase detection. The input polarizer (P1) and output polarizer (P5) may also be oriented in a series of angles best chosen for extracting the Jones matrix of the sample (S), where each set of angles requires at least one measurement by the detector or array of detectors. One possible series of angles with respect to the sample axis is θ=0°, φ=0°; θ=90°, φ=0°; θ=0°, φ=90°; and θ=90°, φ=90°. More angles may be used to improve the measurement.

In a third mode of operation, e.g., Mode C in Table 1, measurement of signal magnitude and reflectance phase may be performed with the variable wavelength interferometer having designs II or III shown in FIG. 4B or 4C. In one implementation, the phase of the signal may be determined using a camera (C1) that includes a mask of polarizing filters at the sensor, e.g., as illustrated in FIGS. 7A and 7B. When light incident on the sensor in the camera (C1) consists of opposite circular polarization from the sample and reference arms, which is caused by the quarter-wave plate in P5, then the intensity at each pixel in the sensor is the interference pattern with a phase delay of twice the angle of each polarizer. Hence the interference pattern in the 2×2 pixel blocks varies in multiples of 90°. FIG. 8, by way of example, is a graph illustrating the relative signal value with respect to the path difference varying by multiples of 90° in a 2×2 pixel block. On the assumption that the interference signal is the same at each pixel in one 2×2 block, the intensities at each pixel are given as follows for a source electric field E₀, sample complex reflectance A_{w}exp(iφ_{w}) and reference complex reflectance Aᵣexp(iφᵣ):

$${I}_{0} = \frac{1}{4} {E}_{0}^{2} ( {A}_{w}^{2} + {A}_{r}^{2} + {A}_{w} {A}_{r} sin ( {φ}_{w} - {φ}_{r} ) ) \qquad eq . 5 a$$

$${I}_{45} = \frac{1}{4} {E}_{0}^{2} ( {A}_{w}^{2} + {A}_{r}^{2} + {A}_{w} {A}_{r} cos ( {φ}_{w} - {φ}_{r} ) ) \qquad eq . 5 b$$

$${I}_{90} = \frac{1}{4} {E}_{0}^{2} ( {A}_{w}^{2} + {A}_{r}^{2} - {A}_{w} {A}_{r} sin ( {φ}_{w} - {φ}_{r} ) ) \qquad eq . 5 c$$

$${I}_{135} = \frac{1}{4} {E}_{0}^{2} ( {A}_{w}^{2} + {A}_{r}^{2} - {A}_{w} {A}_{r} cos ( {φ}_{w} - {φ}_{r} ) ) . \qquad eq . 5 d$$

Angles ψ and Δ, may be calculated as:

$$Ψ ≡ {tan}^{- 1} ( \frac{{A}_{w}}{{A}_{r}} ) = \frac{1}{2} {sin}^{- 1} ( \frac{4 \sqrt{{( {I}_{0 , w} - {I}_{90 , w} )}^{2} + {( {I}_{45 , w} - {I}_{135 , w} )}^{2}}}{{I}_{0 , w} + {I}_{90 , w} + {I}_{45 , w} + {I}_{135 , w}} ) \qquad eq . 6 a$$

$$Δ ≡ {φ}_{w} - {φ}_{r} = {tan}^{- 1} ( \frac{{I}_{0} - {I}_{90}}{{I}_{45} - {I}_{135}} ) \qquad eq . 6 b$$

The reference complex reflectance is fixed and may be known, for example using measurements with an ellipsometer. Hence equations 6a and 6b may be used to measure the complex reflectance of the sample, A_{w}exp(iφ_{w}).

The value Ψ determined by eq. 6a has two solutions and loses sensitivity near Ψ=π/4, that is when A_{w}=Aᵣ. This problem can be solved by using signals obtained periodically from a reference sample with known properties, so that the measured signal is relative to that of the reference sample(s), and denoted Ψ_{w,s} and Δ_{w,s}:

$${Ψ}_{w , s} = {tan}^{- 1} ( \frac{{( {I}_{0 , w} - {I}_{90 , w} )}^{2} + {( {I}_{45 , w} - {I}_{1 \; 35 , w} )}^{2}}{{( {I}_{0 , s} - {I}_{90 , s} )}^{2} + {( {I}_{45 , s} - {I}_{135 , s} )}^{2}} ) \qquad eq . 6 c$$

$${Δ}_{w , s} = {φ}_{w} - {φ}_{s} \qquad eq . 6 d$$

In a fourth mode of operation, e.g. Mode D in Table 1, measurement of signal magnitude and reflectance phase may be performed with the variable wavelength interferometer having designs II or III shown in FIG. 4B or 4C. In one implementation, the phase of the signal may be determined using a camera (C1) that includes a mask of polarizing filters at the sensor, e.g., as illustrated in FIGS. 7A and 7B. When the light incident on camera (C1) consists of opposite linear polarization from the reference and sample arms, one pixel of the 2×2 pixel block will be aligned to the reference and one will be aligned to the sample. Assuming the interference pattern is the same at each pixel in the 2×2 block the relative intensities for each orientation of the polarizing mask are given as follows:

$${I}_{0} = \frac{1}{2} {A}_{w}^{2} {E}_{0}^{2} \qquad eq . 7 a$$

$${I}_{45} = \frac{1}{4} {E}_{0}^{2} ( {A}_{w}^{2} + {A}_{r}^{2} + 2 {A}_{w} {A}_{r} cos ( {φ}_{w} - {φ}_{r} ) ) \qquad eq . 7 b$$

$${I}_{90} = \frac{1}{2} {A}_{r}^{2} {E}_{0}^{2} \qquad eq . 7 c$$

$${I}_{135} = \frac{1}{4} {E}_{0}^{2} ( {A}_{w}^{2} + {A}_{r}^{2} - 2 {A}_{w} {A}_{r} cos ( {φ}_{w} - {φ}_{r} ) ) . \qquad eq . 7 d$$

In one implementation, the amplitude ratio (Ψ) and phase (Δ) can be extracted from the intensities of the 2×2 block of masked pixels above with the following formulas:

$$Ψ ≡ {tan}^{- 1} ( \frac{{A}_{w}}{{A}_{r}} ) = {tan}^{- 1} ( \sqrt{\frac{{I}_{0}}{{I}_{90}}} ) \qquad eq . 8 a$$

$$Δ ≡ {φ}_{w} - {φ}_{r} = {cos}^{- 1} ( \frac{{I}_{45} - {I}_{135}}{2 \sqrt{{I}_{0}} \sqrt{{I}_{90}}} ) \qquad eq . 8 b$$

The value Δ determined by eq. 8b loses sensitivity when φ_{w}−φᵣ≈π/2. One means of avoiding this problem is to acquire two images with a known change in reference optical path of 2kζ between acquisitions. Then:

$$Ψ = {tan}^{- 1} ( \sqrt{\frac{{I}_{0 , - k ζ} + {I}_{0 , k ζ}}{{I}_{90 , - k ζ} + {I}_{90 , k ζ}}} ) \qquad eq . 8 c$$

$$And with :$$

$${C}_{x} = \frac{{I}_{45 , x} - {I}_{135 , x}}{2 \sqrt{{I}_{0 , x} {I}_{90 , x}}} \qquad eq . 8 d$$

$$Δ = {tan}^{- 1} ( \frac{1}{tan ( k ζ )} ( \frac{{C}_{- k ζ} - {C}_{k ζ}}{{C}_{- k ζ} + {C}_{k ζ}} ) ) 8 e \qquad eq . 8 e$$

In a fifth mode of operation, e.g. Mode E in Table 1, measurement of signal magnitude and reflectance phase may be performed with the variable wavelength interferometer having designs II or III shown in FIG. 4B or 4C. In this mode the beamsplitter B1 is polarizing, and the polarizing elements P3 and P4 are quarter-wave plates. The operation in Mode E uses circular polarization at the sample (S) utilizing the polarizing beamsplitter and a quarter-wave plate polarizing element in P3. The quarter-wave plate P3 may be at any angle with respect to the sample axes, i.e., the axes of the patterns on the sample (S), such as 0°, 45°, or 90°. The selected orientation of the quarter-wave plate may be varied based on the sample (S) to optimize the sample contribution to the signal. While the angle of the quarter-wave plate (θ) in the sample arm may be chosen for the best signal to noise ratio, it should nominally be 45° or −45° for maximum light transmission. One possible means of phase extraction may include alternately shuttering the reference arm and sample arm and collecting data with the camera (C1) in both configurations. A third image is captured by camera C1 with both shutters open and the resulting interference between the reference and sample arms is proportional to the phase difference.

In a sixth mode of operation, e.g. Mode F in Table 1, measurement of signal magnitude and reflectance phase may be performed with the variable wavelength interferometer having designs II or III shown in FIG. 4B or 4C. In this mode the beamsplitter B1 is polarizing, and the polarizing elements P3 and P4 are quarter-wave plates. The operation in Mode E uses circular polarization at the sample (S) utilizing the polarizing beamsplitter and a quarter-wave plate polarizing element in P3. The quarter-wave plate P3 may be at any angle with respect to the sample axes, i.e., the axes of the patterns on the sample (S), such as 0°, 45°, or 90°. The selected orientation of the quarter-wave plate may be varied based on the sample (S) to optimize the sample contribution to the signal. While the angle of the quarter-wave plate (θ) in the sample arm may be chosen for the best signal to noise ratio, it should nominally be 45° or −45° for maximum light transmission. When light incident on the sensor in the camera (C1) consists of opposite circular polarization from the sample and reference arms, which is caused by the quarter-wave plate in P5, then the intensity at each pixel in the sensor is the interference pattern with a phase delay of twice the angle of each polarizer. This mode is then functionally equivalent to mode C and amplitude ratio and phase information can be extracted in the same manner.

In a seventh mode of operation, e.g. Mode G in Table 1, measurement of signal magnitude and reflectance phase may be performed with the variable wavelength interferometer having designs II or III shown in FIG. 4B or 4C. In this mode the beamsplitter B1 is polarizing, and the polarizing elements P3 and P4 are quarter-wave plates. The operation in Mode E uses circular polarization at the sample (S) utilizing the polarizing beamsplitter and a quarter-wave plate polarizing element in P3. The quarter-wave plate P3 may be at any angle with respect to the sample axes, i.e., the axes of the patterns on the sample (S), such as 0°, 45°, or 90°. The selected orientation of the quarter-wave plate may be varied based on the sample (S) to optimize the sample contribution to the signal. While the angle of the quarter-wave plate (θ) in the sample arm may be chosen to for the best signal to noise ratio, it should nominally be 45° or −45° for maximum light transmission. When the light incident on camera (C1) consists of opposite linear polarization from the reference and sample arms, one pixel of the 2×2 pixel block will be aligned to the reference and one will be aligned to the sample. This mode is then functionally equivalent to mode D and amplitude ratio and phase information can be extracted in the same way.

In one implementation of mode G, the measurement may be repeated at least four times with each measurement using a different rotation angle (ϕ) between the system default polarization axis and the quarter-wave plate in the P3 position as shown in FIGS. 4B and 4C. If θ represents the angle of the plane-of-incidence for a given pixel in the detector the relationship between individual measurements and the sample Jones matrix is given by:

$${α}_{\pm } ( ϕ ) = sin ( 2 θ ) + sin ( 4 ϕ + 2 θ ) \pm 2 i sin ( 2 ϕ ) \qquad eq . 9 a$$

$${β}_{\pm } ( ϕ ) = 2 \pm cos ( 2 θ ) \pm cos ( 4 ϕ + 2 θ ) \qquad eq . 9 b$$

$${M}_{ϕ} = tan ( {Ψ}_{ϕ} ) {e}^{i {Δ}_{ϕ}} \qquad eq . 9 c$$

$$[ \begin{matrix}{M}_{ϕ 1} \\ {M}_{ϕ 2} \\ {M}_{ϕ 3} \\ {M}_{ϕ 4}\end{matrix} ] = \frac{1}{4} [ \begin{matrix}{α}_{-} ( ϕ 1 ) & {β}_{-} ( ϕ 1 ) & {β}_{+} ( ϕ 1 ) & {α}_{+} ( ϕ 1 ) \\ {α}_{-} ( ϕ 2 ) & {β}_{-} ( ϕ 2 ) & {β}_{+} ( ϕ 2 ) & {α}_{+} ( ϕ 2 ) \\ {α}_{-} ( ϕ 3 ) & {β}_{-} ( ϕ 3 ) & {β}_{+} ( ϕ 3 ) & {α}_{+} ( ϕ 3 ) \\ {α}_{-} ( ϕ 4 ) & {β}_{-} ( ϕ 4 ) & {β}_{+} ( ϕ 4 ) & {α}_{+} ( ϕ 4 )\end{matrix} ] [ \begin{matrix}{J}_{pp} \\ {J}_{ps} \\ {J}_{sp} \\ {J}_{ss}\end{matrix} ] \qquad eq . 9 d$$

This matrix is invertible so the sample Jones matrix components can be recovered from at least 4 measurements. The system can be overdetermined by increasing the number of measurements, which extends the matrix above but is solved in the same manner. System non-idealities may prevent invertibility, in which case the original measured signals can be modeled.

The phase of the signal received by the camera (C1) may be modulated for each wavelength. One advantage of modulation is to improve sensitivity for measurement of Y or A as discussed in deriving eq. 6c and 8e. Modulation of the phase of the signal may be achieved, e.g., using the modulator (M), or by movement of the reference objective and objective to produce path-difference scanning. It should be noted that while the scanning white-light interferometer 100 shown in FIG. 1 uses path-difference scanning, it must scan all the way through the interference signal and the spectrum is derived from the FFT. Accordingly, the longer the scan with scanning white-light interferometer 100 the finer the wavelength resolution, e.g., 60 μm scans may be used. Since the variable wavelength interferometer is operating with a narrow spectral bandwidth, the modulation envelope of the interference pattern will vary slowly with the path difference. It is therefore only necessary to move the reference arm by the length of a single interference cycle (as shown in FIG. 8), e.g., scanning a single fringe of approximately 300 nm, which is used to measure the signal phase that is the value of kζ at which the signal amplitude is midway between minimum and maximum. If the modulator (M) is used to modulate the phase of the signal, then it is also only necessary to vary the phase delay between 0° and 360°. Hence the time taken to collect the varying signals is minimized and errors introduced by system vibration are reduced relative to those in a broad bandwidth path difference scanning system, such as illustrated in FIG. 1.

Alternatively, if the modulator (M) is used to modulate the phase of the signal, multiple signals can be acquired by the camera (C1), and a Fourier Transform may be used to determine amplitude and phase at the known oscillating frequency. Another method may use a lock-in amplifier to determine the signal amplitude and phase. For example, in some implementations, a separate lock-in detector would be implemented for each pixel, such as is available from Heliotis AG. The use of a lock-in amplifier may be beneficial as a method of signal to noise enhancement for weak signals.

In another implementation, the measurement of the phase may be performed by blocking the reference beam. For example, with a suitable interferometric objective, such as a Linnik configuration illustrated in FIG. 5C, it is possible to acquire a sample signal, Iₛ, with the reference beam blocked, e.g., using a reference shutter 522 shown in FIG. 5C. Additionally, reference signal, Iᵣ, may be obtained from the reference arm alone, e.g., with no sample present, and at the same exposure time, e.g., during a calibration procedure, or using a shutter in the sample arm of the interferometric objective.

With wavelength variation, all parts of the variable wavelength interferometer may be stationary while a signal is acquired at one wavelength or different phases of the signal may be generated for each wavelength, e.g., by altering the path difference or using modulator (M). If the reference shutter 522 in FIG. 5C is placed on a rotating wheel then the signal will alternate between sample signal, Iₛ, and the interferometer signal, I. The reference signal, Iᵣ, may be measured as a calibration operation as frequently as required. The reference shutter rotation speed and the size of its open portion may be selected such that one or more interferometer signals, I, can be obtained, then one or more sample signals, Iₛ, without needing to wait for the shutter wheel to stop and start, thereby reducing the time required to perform the measurements.

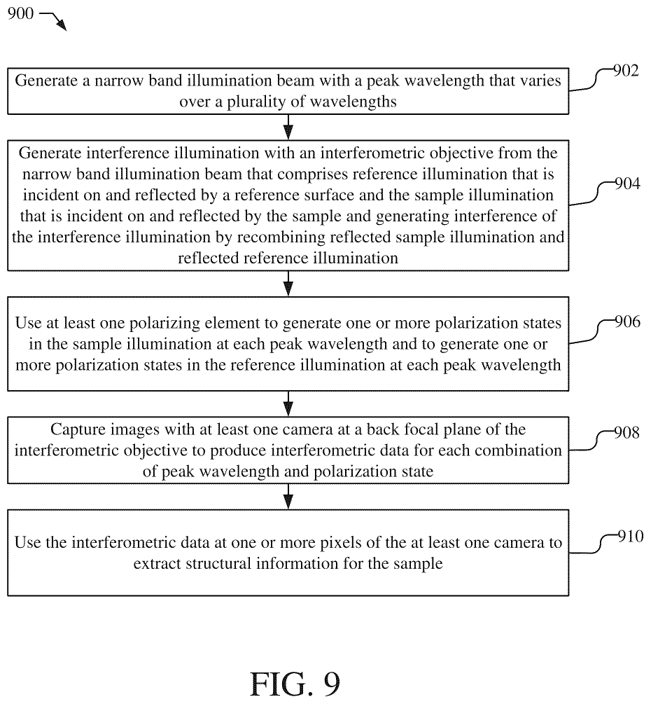

FIG. 9 is a flow chart 900 illustrating a method of characterizing a sample with an interferometer, such as with the variable wavelength interferometer 300, as illustrated in FIG. 3, using any of the designs illustrated in FIGS. 4A, 4B, 4C, and 4D, as discussed herein.

At block 902, a narrow band illumination beam is generated with a peak wavelength that varies over a plurality of wavelengths, e.g., as discussed with respect to light source 310 illustrated in FIG. 3. In some implementations, the narrow band illumination beam is generated with a peak wavelength that varies over a plurality of wavelengths by selecting the peak wavelengths of the narrow band illumination beam based on properties of the sample.

At block 904, interference illumination is generated with an interferometric objective from the narrow band illumination beam that comprises reference illumination that is incident on and reflected by a reference surface and sample illumination that is incident on and reflected by the sample and interference of the interference illumination is generated by recombining reflected sample illumination and reflected reference illumination, e.g., as discussed with respect to interference objective 330 illustrated in FIG. 3.

At block 906, at least one polarizing element is used to generate at one or more polarization states in the sample illumination at each peak wavelength and to generate one or more polarization states in the reference illumination at each peak wavelength, e.g., as discussed with reference to polarization state generators 313, 317, and 318 in FIG. 3. In one implementation, the at least one polarizing element may be a first polarizing element in a beam path of the sample illumination and a second polarizing element in a beam path of the reference illumination, as illustrated by polarization state generators 317 and 318 in FIG. 3. In one implementation, the at least one polarizing element may be a first polarizing element in a beam path of the narrow band illumination beam, e.g., as illustrated by polarization state generator 313 in FIG. 3.

At block 908, images are captured with at least one camera at a back focal plane of the interferometric objective to produce interferometric data for each combination of peak wavelength and polarization state, e.g., as discussed with respect to camera 340 illustrated in FIG. 3. In some implementations, two or more path length differences between the reference illumination and the sample illumination may be generated at each peak wavelength, e.g., as discussed with reference to the objective 336 and the mirror 338 in FIG. 3. A means for generating two or more path length differences between the reference illumination and the sample illumination at each peak wavelength may be, for example, the objective 336 and the mirror 338 in FIG. 3. In such implementations, the interferometric data is produced for each combination of peak wavelength, and polarization state, and path length difference, e.g., as discussed with respect to camera 340 illustrated in FIG. 3.

At block 910, the interferometric data at one or more pixels of the at least one camera is used to extract structural information for the sample, e.g., as discussed with respect to processing system 360 illustrated in FIG. 3.

For example, the interferometric data at one or more pixels of the at least one camera may be used to extract structural information for the sample by determining the reflectance of the sample at the one or more pixels and at each peak wavelength. The interferometric data, for example, may include intensity with respect to wavelength for each pixel. The sample reflectance may be determined by extracting a complex reflectance between illumination that is incident on the sample and the reflected sample illumination that is reflected by the sample, the complex reflectance being a function of azimuth angle and angle of incidence. The structural information for the sample may be determined as one or more characteristics of the sample based on the complex reflectance. The complex reflectance, for example, may be determined as a ratio between incident and emergent electric fields.

In one example, the interferometric data at one or more pixels of the at least one camera may be used to extract structural information for the sample by determining the Jones matrix of the sample at one or more pixels and at each peak wavelength. In some implementations, the measurement may be repeated at least four times with each measurement using a different combination of incident and measured polarization states to determine the Jones matrix. This process can then be repeated at any peak wavelength of interest.

In some implementations, the interferometric data may be produced by circularly polarizing the sample illumination with the at least one polarizing element and circularly polarizing the reference illumination with the at least one polarizing element, where the sample illumination and the reference illumination may be circularly polarized in opposite directions. Moreover, the interference illumination may be captured with the at least one camera with a plurality of polarization states at each pixel, e.g., as discussed with reference to dotted block 352 and the camera 340 in FIG. 3. A complex reflectance between illumination that is incident on the sample and the reflected sample illumination from the sample is extracted based on the interference illumination captured at a plurality of polarization states at each pixel.

In some implementations, the interferometric data may be produced by generating two or more path length differences between the reference illumination and the sample illumination at each peak wavelength, e.g., as discussed with reference to the objective 336 and the mirror 338 in FIG. 3. Additionally, the interferometric data may be produced by circularly polarizing the sample illumination with the at least one polarizing element and circularly polarizing the reference illumination with the at least one polarizing element, where the sample illumination and the reference illumination may be circularly polarized in opposite directions. Moreover, the interference illumination may be captured with at least one camera at the two or more path length differences between the reference illumination and the sample illumination, e.g., as discussed with reference to dotted block 352 and the camera 340 in FIG. 3. A complex reflectance between illumination that is incident on the sample and the reflected sample illumination from the sample is extracted based on the interference illumination captured the two or more path length differences between the reference illumination and the sample illumination.

In some implementations, the interferometric data may be produced by linearly polarizing the sample illumination with the at least one polarizing element and linearly polarizing the reference illumination with the at least one polarizing element, where polarization states of the sample illumination and the reference illumination may be orthogonal. Moreover, the interference illumination may be captured with the at least one camera that captures the interference illumination at plurality of polarization states at each pixel, e.g., as discussed with reference to dotted block 352 and the camera 340 in FIG. 3. A complex reflectance between illumination that is incident on the sample and the reflected sample illumination from the sample is extracted based on the interference illumination captured at the plurality of polarization states at each pixel.

In some implementations, the interferometric data may be produced by modulating a phase of the interference illumination or modulating the narrow band illumination beam to modulate the phase of the interference illumination and extracting a complex reflectance between illumination that is incident on the sample and the reflected sample illumination from the sample based on modulating the phase of the interference illumination, e.g., as discussed with reference to a modulator and dotted block 354 in FIG. 3. A means for modulating a phase of the interference illumination or modulating the narrow band illumination beam to modulate the phase of the interference illumination may be, e.g., a modulator, such as a PEM, illustrated with block 354 in FIG. 3 and represented by M in FIGS. 4A-4C.

In some implementations, the process may further include generating two or more path length differences between the reference illumination and the sample illumination by moving the reference mirror to modulate a phase of the interference illumination and the interferometric data may be produced by extracting a phase change between illumination that is incident on the sample and the reflected sample illumination from the sample based on modulating the phase of the interference illumination, e.g., as discussed with reference to the objective 336 and the mirror 338 in FIG. 3.

In some implementations, the interferometric data may be produced by blocking illumination directed to the reference surface with a shutter, e.g., as discussed with reference to a shutter and dotted block 356 in FIG. 3. Images of the back focal plane of the interferometric objective may be captured with the at least one camera for only the sample illumination when the shutter blocks illumination directed to the reference surface, and the interferometric data may be produced by extracting a complex reflectance between illumination that is incident on the sample and the reflected sample illumination from the sample based on the imaged interference illumination and imaged reflected sample illumination.

In some implementations, the sample focus may be adjusted, e.g., to correct for dispersion in the sample objective of the interferometric objective. Additionally, the reference arm position may be adjusted to allow for dispersion in the reference objective.

Additionally, in some implementations, one or more images may be collected using the at least one camera while keeping the system static and recording the source intensity with detector (D) shown in FIGS. 4A, 4B, and 4C.

Compared to a path difference scanning system, such as illustrated in FIG. 1, the variable wavelength interferometer 300 offers a number of advantages. For example, there is no requirement that the variable wavelength interferometer system be stable throughout the entire acquisition since the series of detected images at multiple wavelengths provide the desired spectral content directly. System stability during acquisition of each image is required, but for sufficient source intensity the exposure time will be of order 1 ms, compared to the 1 s or more required to complete a phase scan with a path difference scanning system. Dispersive effects in the optical system, which may change the distance to focus the sample, may be corrected. Variation of the source intensity with wavelength may be compensated by varying the number of images, and/or the exposure time for each image. Knowledge of the source intensity may be obtained through calibration or by using detector (D) during the measurement. In addition to adjusting for the spectral content of the light source, collecting multiple images at each point allows for improvement in final signal-to-noise levels beyond what can be achieved by any camera in a single image. There is no requirement limiting the number or spacing of wavelength steps, or that wavelength steps need be uniform. Only those wavelengths known to be most sensitive to change in desired sample properties need be selected. The mapping between pixel (x,y) and angles (θ,φ) may not be constant with wavelength, and can be determined by calibration or some other means and then applied independently to data collected at each wavelength. The spectral resolution of the tool is determined by the properties of the wavelength tunable light source, such as properties of filter (F), whereas in a path difference scanning tool it is determined by the total scanned length, requiring scans of 60 μm to achieve an equivalent resolution. Longer scans equate to slower operation and greatly increase the need for platform stability.

A system model that describes the variable wavelength interferometer discussed herein may be used to simulate the expected measurement results. Compared to the system illustrated in FIG. 1, which obtains data as a map of the back focal plane of the objective that is a function of scanner position, i.e., z, and which must be Fourier transformed to move into wavelength space allowing analysis of the results, with the variable wavelength interferometer, the Fourier transform is unnecessary as the measured data will be a map of the back focal plane of the objective as a function of wavelength.

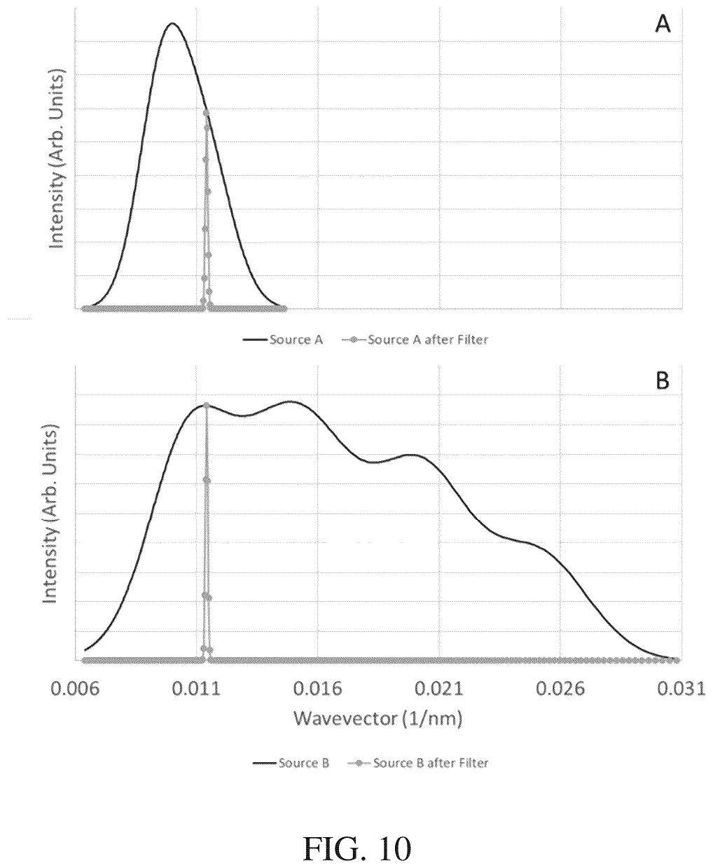

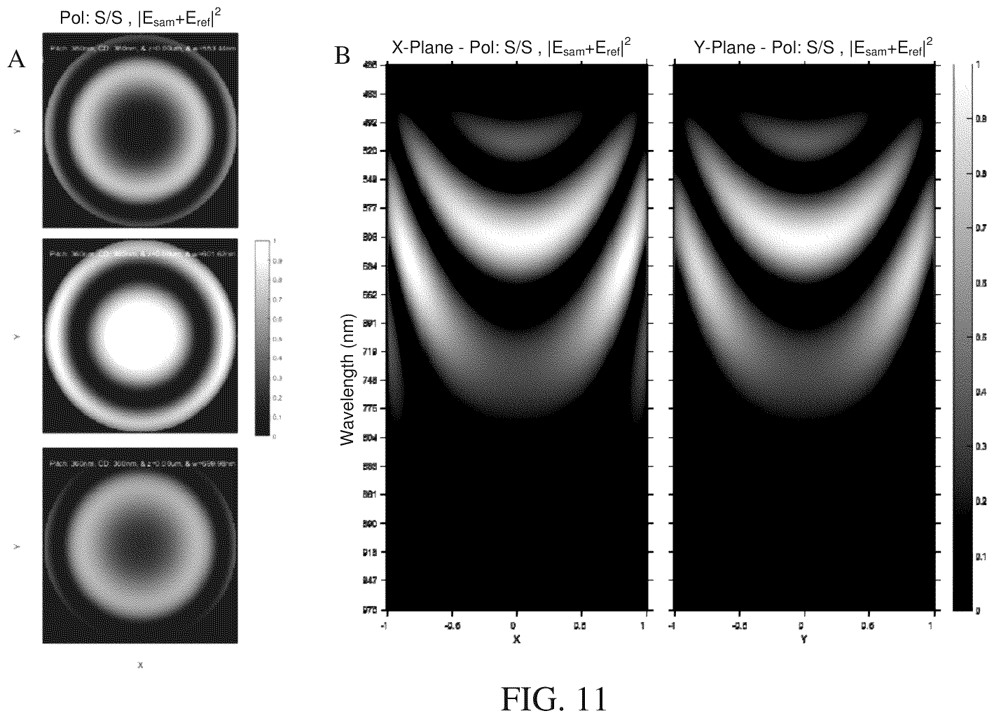

FIG. 10 illustrates two light sources with varying emission spectra that were used for the simulations, with spectra A used in the simulations shown in FIGS. 11-13, 15 and 16 and spectra B used in simulations shown in FIGS. 14, 17 and 18. The first step in the simulation was to compute the Jones matrix for the sample of interest using the rigorous coupled wave approximation (RCWA) across the wavelength (source), angle of incidence (0° to 90°), and azimuthal angles (0° to 360°) of interest on a grid (128×128) like that of the camera pixel grid. This input was used in the system model to create the result for the back focal plane of the objective as a function of wavelength. The wavelength filter for this study was assumed to have a Gaussian character with fixed width in wavevector space (5E-5 l/nm), i.e., the filter is energy dispersive. An example of the filtered spectrum at 550 nm is shown in FIG. 10. Note that in this calculation the intensity of the filtered spectrum is set by the assumed emission spectrum and thus the signal level is completely dependent on source intensity.

FIG. 11 illustrates the results of simulation for a variable wavelength interferometer measuring a 1 μm SiO2 film on a Si substrate using source A from FIG. 10 in polarizer configuration at z=0 nm, where (A) illustrates the image at the back focal plane of the objective at wavelengths 550 nm (top), 600 nm (middle), and 650 nm (bottom), and (B) illustrates X and Y planes as a function of wavelength. As illustrated, the simulation exhibits radial symmetry in the back focal plane of the objective as expected.

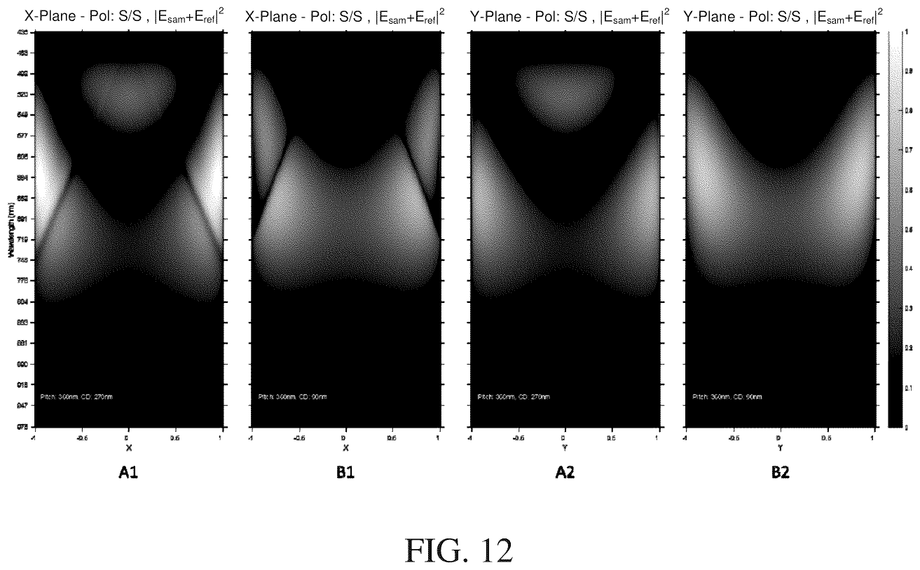

The response from patterned structures, i.e., SiO2 gratings on Si, are predictably more complex, e.g., as illustrated by FIGS. 12-18.

FIG. 12 illustrates the results of simulation for a patterned structure with 360 nm pitch, 270/90 nm (A/B) CD etched into a 300 nm SiO2 film with 24 nm of Si over-etch using source A from FIG. 10 in polarizer configuration from Mode B in Table 1 at zero path difference. X and Y planes as a function of wavelength.

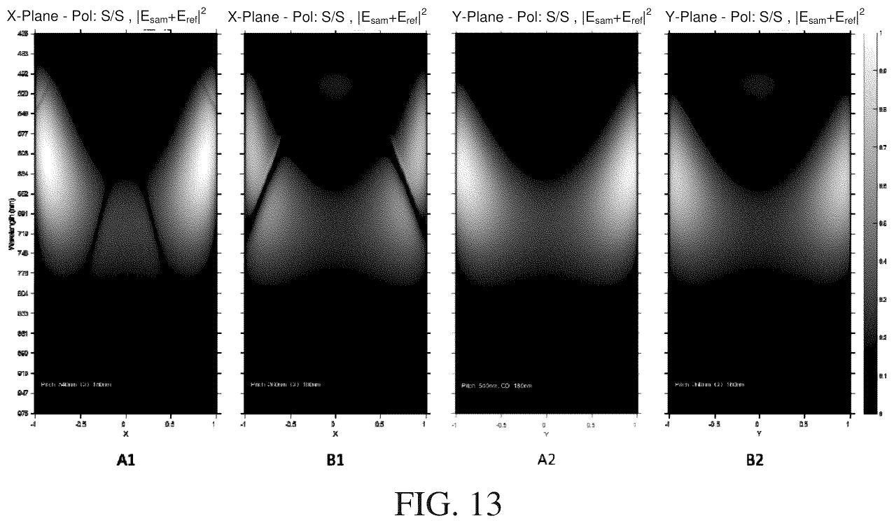

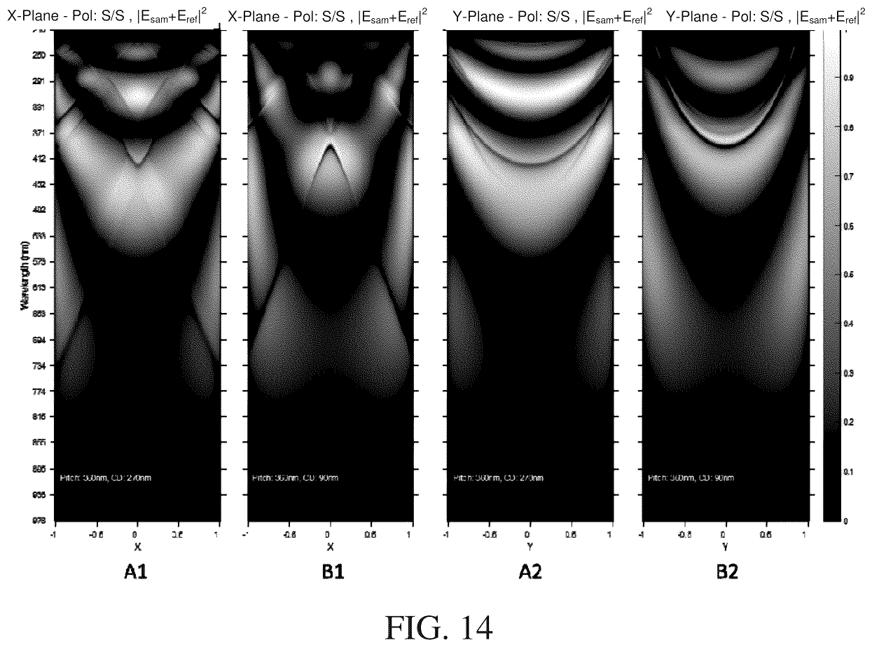

FIG. 13 illustrates the results of simulation for a patterned structure with 540/360 nm (A/B) pitch, 180 nm CD etched into a 300 nm SiO2 film with 24 nm of Si over-etch using source A from FIG. 10 in polarizer configuration from Mode B in Table 1 at zero path difference. X and Y planes as a function of wavelength.

FIG. 14 illustrates the results of simulation for a patterned structure with 360 nm pitch, 270/90 nm (A/B) CD etched into a 300 nm SiO2 film with 24 nm of Si over-etch using source B from FIG. 10 in polarizer configuration from Mode B in Table 1 at zero path difference. X and Y planes as a function of wavelength.

FIGS. 12 and 13 show the impact of changing the CD at fixed pitch and pitch at fixed CD respectively. FIGS. 12 and 14 show the impact of the source spectrum. A lower wavelength may be helpful for resolving smaller CD structures.

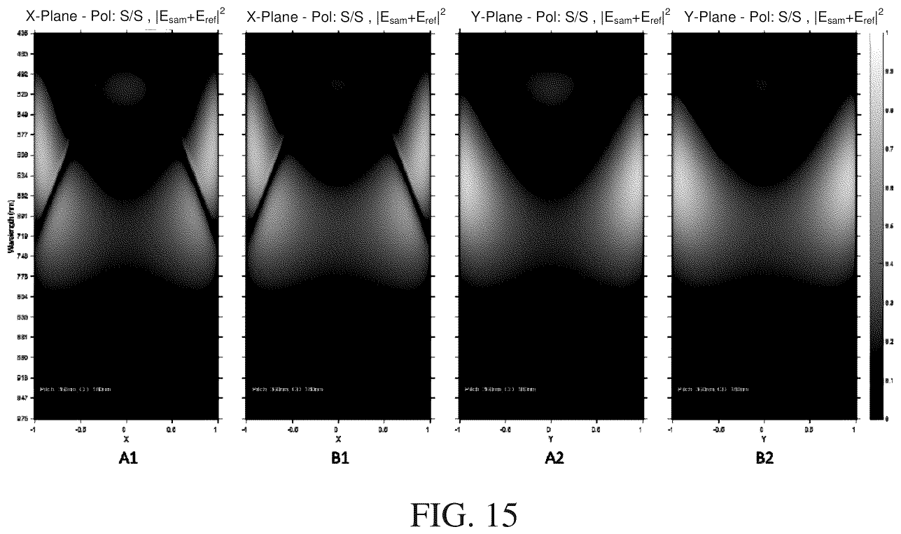

FIG. 15 illustrates the results of simulation for a patterned structure with 360 nm pitch, 180 nm CD etched into a 300 nm SiO2 film with 24 nm of Si over-etch using source A from FIG. 10 in polarizer configuration from Mode B in Table 1 with path difference of +5/−5 μm (A/B). X and Y planes as a function of wavelength.

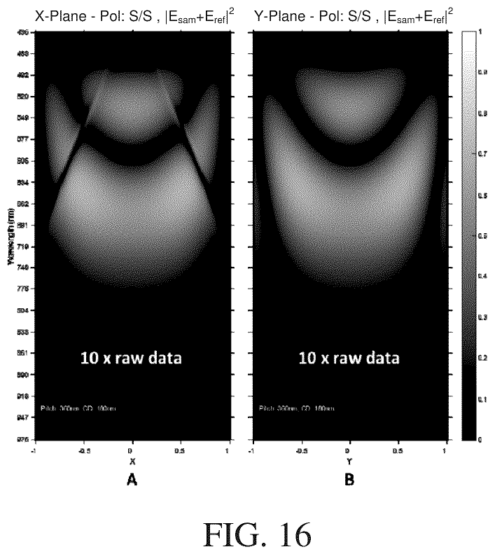

FIG. 16 Illustrates the absolute value of the difference between the two data sets in FIG. 15 multiplied by 10.

All the simulations in FIGS. 11 to 14 assume the reference and sample path in the interferometric objective are the same, i.e., the path difference is zero. In FIG. 15, the path difference is varied between +5 μm and −5 μm. The difference between these two simulations is shown in FIG. 16 with the data magnified by a factor of 10. There is a difference in the data as a function of path difference as expected.

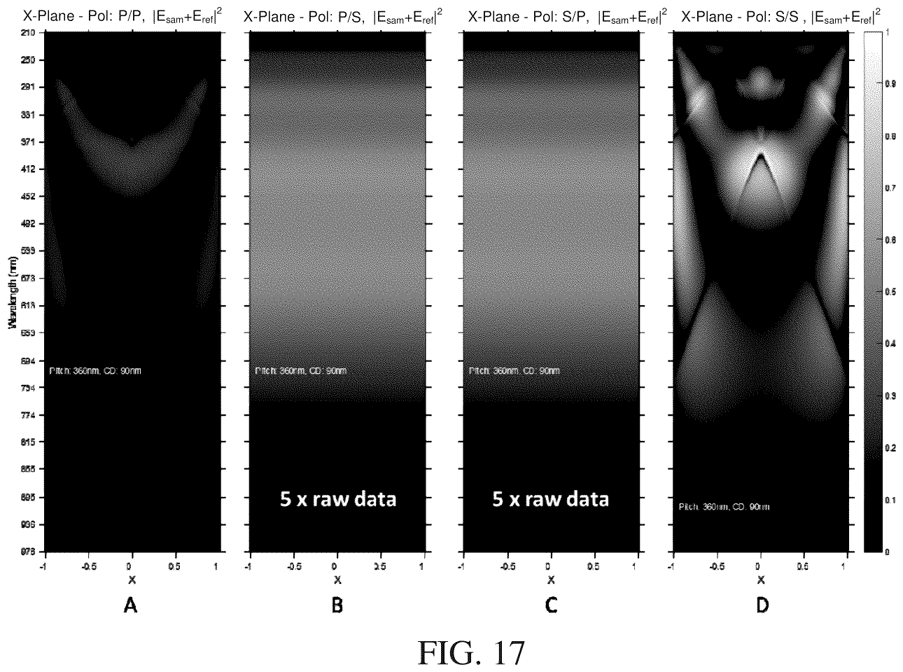

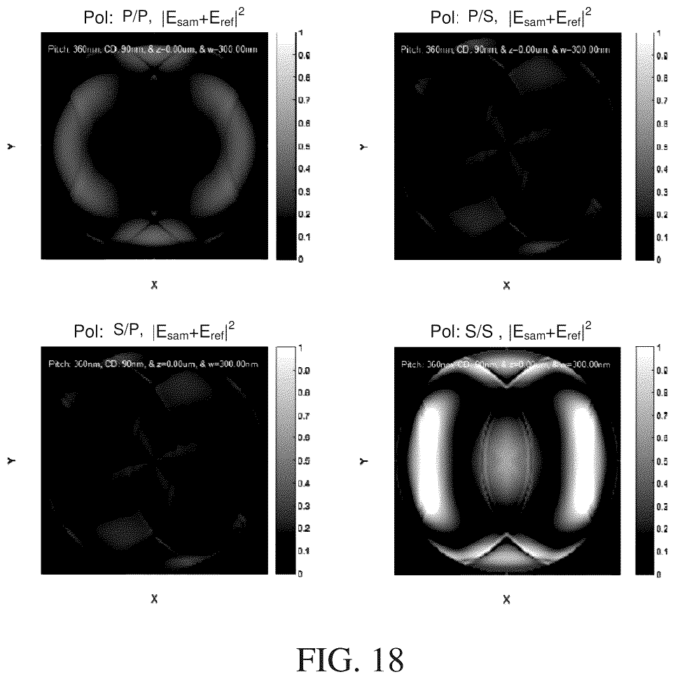

FIG. 17 illustrates the results of simulation for a patterned structure with 360 nm pitch, 90 nm CD etched into a 300 nm SiO2 film with 24 nm of Si over-etch using source B from FIG. 10 in polarizer configuration from Mode B in Table 1, where the input polarizer (P1) may be P or S and the output polarizer (P5) may be P or S, at zero path difference. X and Y planes as a function of wavelength for all combinations.

FIG. 18 illustrates the results of simulation for a patterned structure with 360 nm pitch, 90 nm CD etched into a 300 nm SiO2 film with 24 nm of Si over-etch using source B from FIG. 10 in polarizer configuration from Mode B in Table 1 at zero path difference. Objective back focal plane images at 300 nm as a function of wavelength for all combinations of polarizers (P1) and (P2) orientations.

In FIG. 17 the results of varying the positions of polarizers (P1) and (P5) in the configuration of Mode B in Table 1 are provided. Polarization parallel to the grating provides the highest signal and is the default polarizer orientation used in this simulation. However, similar information appears to exist in the orthogonal orientation. However, the information in the crossed polarizer states is weak. Although weak, some structure does exist but not necessarily on the X and Y axes of the data tube—this data is better visualized in the back focal plane of the objective as illustrated in FIG. 18.

The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method of characterizing a sample with an interferometer, the method comprising:
generating a narrow band illumination beam with a peak wavelength that is varied over a plurality of wavelengths;
generating interference illumination with an interferometric objective from the narrow band illumination beam that comprises reference illumination that is incident on and reflected by a reference surface and sample illumination that is incident on and reflected by the sample and generating interference of the interference illumination by recombining reflected sample illumination and reflected reference illumination;
using at least one polarizing element to generate one or more polarization states in the sample illumination at each peak wavelength and to generate one or more polarization states in the reference illumination at each peak wavelength;
capturing images with at least one camera at a back focal plane of the interferometric objective to produce interferometric data for each combination of peak wavelength and polarization state; and
using the interferometric data at one or more pixels of the at least one camera to extract structural information for the sample.

2. The method of claim 1, wherein the interferometric data at one or more pixels of the at least one camera is used to extract structural information for the sample by determining a reflectance of the sample at the one or more pixels and at each peak wavelength.

3. The method of claim 2, wherein the interferometric data comprises intensity with respect to wavelength for each pixel, and wherein determining the reflectance of the sample comprises:
extracting a complex reflectance between illumination that is incident on the sample and the reflected sample illumination that is reflected by the sample, the complex reflectance being a function of azimuth angle and angle of incidence; and
determining one or more characteristics of the sample based on the complex reflectance.

4. The method of claim 1, wherein the interferometric data at one or more pixels of the at least one camera is used to extract structural information for the sample by determining a Jones matrix of the sample at one or more pixels and at each peak wavelength.

5. The method of claim 1, wherein the at least one polarizing element comprises a first polarizing element in a beam path of the sample illumination and a second polarizing element in a beam path of the reference illumination.

6. The method of claim 1, wherein the at least one polarizing element comprises a first polarizing element in a beam path of the narrow band illumination beam.

7. The method of claim 1, wherein producing the interferometric data comprises:
circularly polarizing the sample illumination with the at least one polarizing element;
circularly polarizing the reference illumination with the at least one polarizing element, wherein the sample illumination and the reference illumination are circularly polarized in opposite directions;
capturing the interference illumination with the at least one camera at a plurality of polarization states at each pixel; and
extracting a complex reflectance between illumination that is incident on the sample and the reflected sample illumination from the sample based on the interference illumination captured at a plurality of polarization states at each pixel.

8. The method of claim 1, wherein producing the interferometric data comprises:
generating two or more path length differences between the reference illumination and the sample illumination at each peak wavelength;
circularly polarizing the sample illumination with the at least one polarizing element;
circularly polarizing the reference illumination with the at least one polarizing element, wherein the sample illumination and the reference illumination are circularly polarized in opposite directions;
capturing the interference illumination with at least one camera at the two or more path length differences between the reference illumination and the sample illumination; and
extracting a complex reflectance between illumination that is incident on the sample and the reflected sample illumination from the sample based on the interference illumination captured at the two or more path length differences between the reference illumination and the sample illumination.

9. The method of claim 1, wherein producing the interferometric data comprises:
linearly polarizing the sample illumination with the at least one polarizing element;
linearly polarizing the reference illumination with the at least one polarizing element, wherein polarization states of the sample illumination and the reference illumination are orthogonal;
capturing the interference illumination with the at least one camera that captures the interference illumination at a plurality of polarization states at each pixel; and
extracting a complex reflectance between illumination that is incident on the sample and the reflected sample illumination from the sample based on the interference illumination captured at the plurality of polarization states at each pixel.

10. The method of claim 1, wherein producing the interferometric data comprises modulating a phase of the interference illumination or modulating the narrow band illumination beam to modulate the phase of the interference illumination and extracting a complex reflectance between illumination that is incident on the sample and the reflected sample illumination from the sample based on modulating the phase of the interference illumination.

11. The method of claim 1, further comprising generating two or more path length differences between the reference illumination and the sample illumination by moving the reference surface to modulate a phase of the interference illumination and extracting a complex reflectance between illumination that is incident on the sample and the reflected sample illumination from the sample based on modulating the phase of the interference illumination.

12. The method of claim 1, wherein producing the interferometric data comprises:
blocking illumination directed to the reference surface with a shutter;
capturing images with the at least one camera of the back focal plane of the interferometric objective for only the sample illumination when the shutter blocks illumination directed to the reference surface; and
extracting a complex reflectance between illumination that is incident on the sample and the reflected sample illumination from the sample based on the imaged interference illumination and imaged reflected sample illumination.

13. The method of claim 1, wherein generating the narrow band illumination beam with a peak wavelength that varies over the plurality of wavelengths comprising selecting the peak wavelengths of the narrow band illumination beam based on properties of the sample.

14. An interferometer configured to characterize a sample, the interferometer comprising:
a light source that generates a narrow band illumination beam with a peak wavelength that varies over a plurality of wavelengths;
an interferometric objective that generates interference illumination from the narrow band illumination beam that comprises reference illumination that is incident on and reflected by a reference surface and sample illumination that is incident on and reflected by the sample and that generates interference of the interference illumination by recombining reflected sample illumination and reflected reference illumination;
at least one polarizing element that generates one or more polarization states in the sample illumination at each peak wavelength and generates one or more polarization states in the reference illumination at each peak wavelength;
at least one camera that captures images at a back focal plane of the interferometric objective to produce interferometric data for each combination of peak wavelength and polarization state; and
at least one processor that extracts structural information for the sample using the interferometric data at one or more pixels of the at least one camera.

15. The interferometer of claim 14, wherein the at least one processor is configured to use the interferometric data at one or more pixels of the at least one camera to extract structural information for the sample by determining a reflectance of the sample at the one or more pixels and at each peak wavelength.

16. The interferometer of claim 15, wherein the interferometric data comprises intensity with respect to wavelength for each pixel, and wherein the at least one processor is configured to use the interferometric data at one or more pixels of the at least one camera to extract structural information for the sample by being configured to:
extract a complex reflectance between illumination that is incident on the sample and the reflected sample illumination that is reflected by the sample, the complex reflectance being a function of azimuth angle and angle of incidence; and
determine one or more characteristics of the sample based on the complex reflectance.

17. The interferometer of claim 14, wherein the at least one processor is configured to use the interferometric data at one or more pixels of the at least one camera to extract structural information for the sample by determining a Jones matrix of the sample at one or more pixels and at each peak wavelength.

18. The interferometer of claim 14, wherein the at least one polarizing element comprises a first polarizing element in a beam path of the sample illumination and a second polarizing element in a beam path of the reference illumination.

19. The interferometer of claim 14, wherein the at least one polarizing element comprises a first polarizing element in a beam path of the narrow band illumination beam.

20. The interferometer of claim 14, wherein:
the at least one polarizing element is configured to circularly polarize the sample illumination;
the at least one polarizing element is further configured to circularly polarize the reference illumination, wherein the sample illumination and the reference illumination are circularly polarized in opposite directions;
the at least one camera captures the interference illumination at plurality of polarization states at each pixel; and
the at least one processor is configured to use the interferometric data at one or more pixels of the at least one camera by extracting a complex reflectance between illumination that is incident on the sample and the reflected sample illumination from the sample based on the interference illumination captured at a plurality of polarization states at each pixel.

21. The interferometer of claim 14, further comprising a means for generating one or more path length differences between the reference illumination and the sample illumination at each peak wavelength, wherein:
the at least one polarizing element is configured to circularly polarize the sample illumination;
the at least one polarizing element is further configured to circularly polarize the reference illumination, wherein the sample illumination and the reference illumination are circularly polarized in opposite directions;
the at least one camera captures the interference illumination at two or more path length differences between the reference illumination and the sample illumination; and
the at least one processor is configured to use the interferometric data at one or more pixels of the at least one camera by extracting a complex reflectance between illumination that is incident on the sample and the reflected sample illumination from the sample based on the interference illumination captured at the two or more path length differences between the reference illumination and the sample illumination.

22. The interferometer of claim 14, wherein:
the at least one polarizing element is configured to linearly polarize the sample illumination;
the at least one polarizing element is configured to linearly polarize the reference illumination, wherein polarization states of the sample illumination and the reference illumination are orthogonal;
the at least one camera captures the interference illumination at plurality of polarization states at each pixel; and
the at least one processor is configured to use the interferometric data at one or more pixels of the at least one camera by extracting a complex reflectance between illumination that is incident on the sample and the reflected sample illumination from the sample based on the interference illumination captured at the plurality of polarization states at each pixel.

23. The interferometer of claim 14, further comprising a means for modulating a phase of the interference illumination or modulating the narrow band illumination beam to modulate the phase of the interference illumination and the at least one processor is configured to use the interferometric data at one or more pixels of the at least one camera by extracting a complex reflectance between illumination that is incident on the sample and the reflected sample illumination from the sample based on modulating the phase of the interference illumination.

24. The interferometer of claim 14, further comprising a moving reference surface to generate two or more path length differences between the reference illumination and the sample illumination at each peak wavelength to modulate a phase of the interference illumination and the at least one processor is configured to use the interferometric data at one or more pixels of the at least one camera by extracting a complex reflectance between illumination that is incident on the sample and the reflected sample illumination from the sample based on modulating the phase of the interference illumination.

25. The interferometer of claim 14, further comprising a shutter configured to block illumination directed to the reference surface, wherein:
the at least one camera is configured to capture images of the back focal plane of the interferometric objective for only the sample illumination when the shutter blocks illumination directed to the reference surface; and
the at least one processor is configured to use the interferometric data at one or more pixels of the at least one camera by extracting a complex reflectance between illumination that is incident on the sample and the reflected sample illumination from the sample based on the imaged interference illumination and imaged reflected sample illumination.

26. The interferometer of claim 14, wherein the light source generates the narrow band illumination beam with a peak wavelength that varies over the plurality of wavelengths by being controlled to select the peak wavelengths of the narrow band illumination beam based on properties of the sample.
